(19) United States
(12) Patent Application Publication
(10) Pub. No.: US 2025/0185055 A1
(43) Pub. Date: Jun. 5, 2025

(54) CONTROL OF A RECONFIGURABLE INTELLIGENT SURFACE SYSTEM

(71) Applicant: QUALCOMM Incorporated, San Diego, CA (US)

(72) Inventors: Ahmed ELSHAFIE, San Diego, CA (US); Alexandros MANOLAKOS, Athens (GR); Yu ZHANG, San Diego, CA (US); Hung Dinh LY, San Diego, CA (US); Seyedkianoush HOSSEINI, San Diego, CA (US)

(21) Appl. No.: 18/840,183

(22) PCT Filed: Mar. 28, 2022
(86) PCT No.: PCT/CN2022/083343

§ 371 Date: Aug. 21, 2024

(51) Int. Cl. H04W 74/0808; H04B 7/04; H04B 17/318; H04W 72/231; H04W 72/25

(52) U.S. Cl. CPC H04W 74/0808; H04B 7/04013; H04B 17/328; H04W 72/231; H04W 72/25

(57) ABSTRACT

In an aspect, a reconfigurable intelligent surface (RIS) controller may perform one or more channel sensing operations to detect whether there are active transmissions on one or more wireless communications channels from one or more network entities that the RIS controller is configured to assist. The RIS may transition a RIS surface coupled to the RIS controller from a deactivated state to an activated state based on detection of the active transmissions on the one or more wireless communications channels from the one or more network entities that the RIS controller is configured to assist.

### CROSS-REFERENCE TO RELATED APPLICATIONS

The present application for patent is a national stage application, filed under 35 U.S.C. § 371, of International Patent Application No. PCT/CN2022/083343, entitled, “CONTROL OF A RECONFIGURABLE INTELLIGENT SURFACE SYSTEM”, filed Mar. 28, 2022, which is assigned to the assignee hereof and is expressly incorporated herein by reference in its entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)) and other technical enhancements.

Leveraging the increased data rates and decreased latency of 5G, among other things, vehicle-to-everything (V2X) communication technologies are being implemented to support autonomous driving applications, such as wireless communications between vehicles, between vehicles and the roadside infrastructure, between vehicles and pedestrians, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a reconfigurable intelligent surface (RIS) controller includes performing one or more channel sensing operations to detect whether there are active transmissions on one or more wireless communications channels from one or more network entities that the RIS controller is configured to assist; and transitioning a RIS surface coupled to the RIS controller from a deactivated state to an activated state based on detection of active transmissions on the one or more wireless communications channels from the one or more network entities that the RIS controller is configured to assist.

In an aspect, a method of wireless communication performed by a reconfigurable intelligent surface (RIS) controller includes transmitting, to a network node, a first transition time capability of the RIS controller, wherein the first transition time capability corresponds to a time needed for the RIS controller to transition from an idle state to an active state; and transmitting, to the network node, a second transition time capability of the RIS controller, wherein the second transition time capability corresponds to a time needed for a RIS surface controlled by the RIS controller to transition from a deactivated state to an activated state.

In an aspect, a method of wireless communication performed by a reconfigurable intelligent surface (RIS) controller includes transitioning to or remaining in an active state based on a first outcome of a first probability function; and transitioning to or remaining in an idle state based on a second outcome of the first probability function.

In an aspect, a reconfigurable intelligent surface (RIS) controller includes a memory; at least one transceiver; and at least one processor communicatively coupled to the memory and the at least one transceiver, the at least one processor configured to: perform one or more channel sensing operations to detect whether there are active transmissions on one or more wireless communications channels from one or more network entities that the RIS controller is configured to assist; and transition a RIS surface coupled to the RIS controller from a deactivated state to an activated state based on detection of active transmissions on the one or more wireless communications channels from the one or more network entities that the RIS controller is configured to assist.

In an aspect, a reconfigurable intelligent surface (RIS) controller includes a memory; at least one transceiver; and at least one processor communicatively coupled to the memory and the at least one transceiver, the at least one processor configured to: transmit, via the at least one transceiver, to a network node, a first transition time capability of the RIS controller, wherein the first transition time capability corresponds to a time needed for the RIS controller to transition from an idle state to an active state; and transmit, via the at least one transceiver, to the network node, a second transition time capability of the RIS controller, wherein the second transition time capability corresponds to a time needed for a RIS surface controlled by the RIS controller to transition from a deactivated state to an activated state.

In an aspect, a reconfigurable intelligent surface (RIS) controller includes a memory; at least one transceiver; and at least one processor communicatively coupled to the memory and the at least one transceiver, the at least one processor configured to: transition to or remain in an active state based on a first outcome of a first probability function; and transition to or remain in an idle state based on a second outcome of the first probability function.

In an aspect, a reconfigurable intelligent surface (RIS) controller includes means for performing one or more channel sensing operations to detect whether there are active transmissions on one or more wireless communications channels from one or more network entities that the RIS controller is configured to assist; and means for transitioning a RIS surface coupled to the RIS controller from a deactivated state to an activated state based on detection of active transmissions on the one or more wireless communications channels from the one or more network entities that the RIS controller is configured to assist.

In an aspect, a reconfigurable intelligent surface (RIS) controller includes means for transmitting, to a network node, a first transition time capability of the RIS controller, wherein the first transition time capability corresponds to a time needed for the RIS controller to transition from an idle state to an active state; and means for transmitting, to the network node, a second transition time capability of the RIS controller, wherein the second transition time capability corresponds to a time needed for a RIS surface controlled by the RIS controller to transition from a deactivated state to an activated state.

In an aspect, a reconfigurable intelligent surface (RIS) controller includes means for transitioning to or remaining in an active state based on a first outcome of a first probability function; and means for transitioning to or remaining in an idle state based on a second outcome of the first probability function.

In an aspect, a non-transitory computer-readable medium stores computer-executable instructions that, when executed by a reconfigurable intelligent surface (RIS) controller, cause the RIS controller to: perform one or more channel sensing operations to detect whether there are active transmissions on one or more wireless communications channels from one or more network entities that the RIS controller is configured to assist; and transition a RIS surface coupled to the RIS controller from a deactivated state to an activated state based on detection of active transmissions on the one or more wireless communications channels from the one or more network entities that the RIS controller is configured to assist.

In an aspect, a non-transitory computer-readable medium stores computer-executable instructions that, when executed by a reconfigurable intelligent surface (RIS) controller, cause the RIS controller to: transmit, to a network node, a first transition time capability of the RIS controller, wherein the first transition time capability corresponds to a time needed for the RIS controller to transition from an idle state to an active state; and transmit, to the network node, a second transition time capability of the RIS controller, wherein the second transition time capability corresponds to a time needed for a RIS surface controlled by the RIS controller to transition from a deactivated state to an activated state.

In an aspect, a non-transitory computer-readable medium stores computer-executable instructions that, when executed by a reconfigurable intelligent surface (RIS) controller, cause the RIS controller to: transition to or remain in an active state based on a first outcome of a first probability function; and transition to or remain in an idle state based on a second outcome of the first probability function.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example frame structure, according to aspects of the disclosure.

FIG. 5 is a diagram illustrating various downlink channels within an example downlink slot, according to aspects of the disclosure.

FIG. 6 illustrates an example system for wireless communication using a reconfigurable intelligent surface (RIS), according to aspects of the disclosure.

FIGS. 7A, 7B, and 7C show example positioning operations in accordance with aspects of the disclosure.

FIG. 8 is a timing diagram showing an example of selectively activating a RIS controller and RIS surface in accordance with aspects of the disclosure.

FIGS. 9A and 9B (collectively “FIG. 9”) are timing diagrams depicting transitioning time capabilities of the RIS system in accordance with aspects of the disclosure.

FIG. 10 is an example of a call flow that may take place between a RIS system and a controlling base station and/or controlling sidelink device to indicate the transitioning time capabilities of the RIS system in accordance with aspects of the disclosure.

FIG. 11 is a timing diagram showing an example of how the RIS system may probabilistically switch between idle, active, activated, and deactivated states in accordance with aspects of the disclosure.

FIG. 12 illustrates an example method of wireless communication performed by a reconfigurable intelligent surface (RIS) controller of an RIS system, according to aspects of the disclosure.

FIG. 13 illustrates an example method of wireless communication performed by a reconfigurable intelligent surface (RIS) controller communication, according to aspects of the disclosure.

FIG. 14 illustrates an example method of wireless communication performed by a reconfigurable intelligent surface (RIS) controller communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE), “vehicle UE” (V-UE), “pedestrian UE” (P-UE), and “base station” are not intended to be specific or otherwise limited to any particular radio access technology (RAT), unless otherwise noted. In general, a UE may be any wireless communication device (e.g., vehicle on-board computer, vehicle navigation device, mobile phone, router, tablet computer, laptop computer, asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as a “mobile device,” an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof.

A V-UE is a type of UE and may be any in-vehicle wireless communication device, such as a navigation system, a warning system, a heads-up display (HUD), an on-board computer, an in-vehicle infotainment system, an automated driving system (ADS), an advanced driver assistance system (ADAS), etc. Alternatively, a V-UE may be a portable wireless communication device (e.g., a cell phone, tablet computer, etc.) that is carried by the driver of the vehicle or a passenger in the vehicle. The term “V-UE” may refer to the in-vehicle wireless communication device or the vehicle itself, depending on the context. A P-UE is a type of UE and may be a portable wireless communication device that is carried by a pedestrian (i.e., a user that is not driving or riding in a vehicle). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs including supporting data, voice and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference RF signals to UEs to be measured by the UEs and/or may receive and measure signals transmitted by the UEs. Such base stations may be referred to as positioning beacons (e.g., when transmitting RF signals to UEs) and/or as location measurement units (e.g., when receiving and measuring RF signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

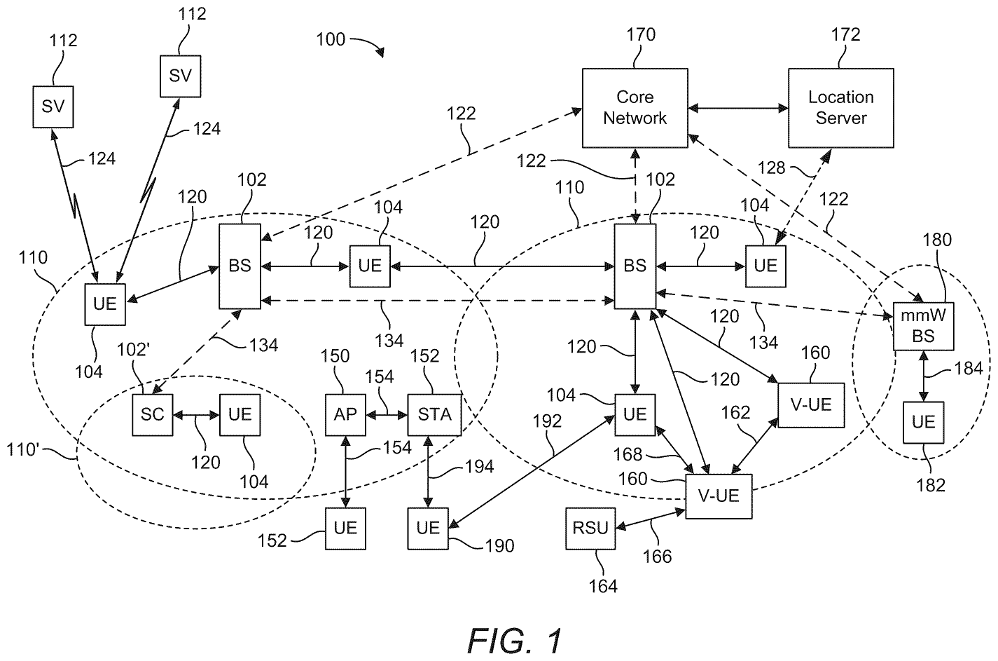

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In an aspect, the macro cell base stations 102 may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-4 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 using the Uu interface (i.e., the air interface between a UE and a base station). V-UEs 160 may also communicate directly with each other over a wireless sidelink 162, with a roadside unit (RSU) 164 (a roadside access point) over a wireless sidelink 166, or with sidelink-capable UEs 104 over a wireless sidelink 168 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, V2V communication, V2X communication (e.g., cellular V2X (cV2X) communication, enhanced V2X (eV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In an aspect, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks 162, 166, 168 may be cV2X links. A first generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHz. Other bands may be allocated in other countries. Thus, as a particular example, the medium of interest utilized by sidelinks 162, 166, 168 may correspond to at least a portion of the licensed ITS frequency band of sub-6 GHz. However, the present disclosure is not limited to this frequency band or cellular technology.

In an aspect, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHz (5.85-5.925 GHz) in the U.S. In Europe, IEEE 802.11p operates in the ITS G5A band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHz.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more RSUs 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more RSUs 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards RSUs 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on. As another example, the D2D P2P links 192 and 194 may be sidelinks, as described above with reference to sidelinks 162, 166, and 168.

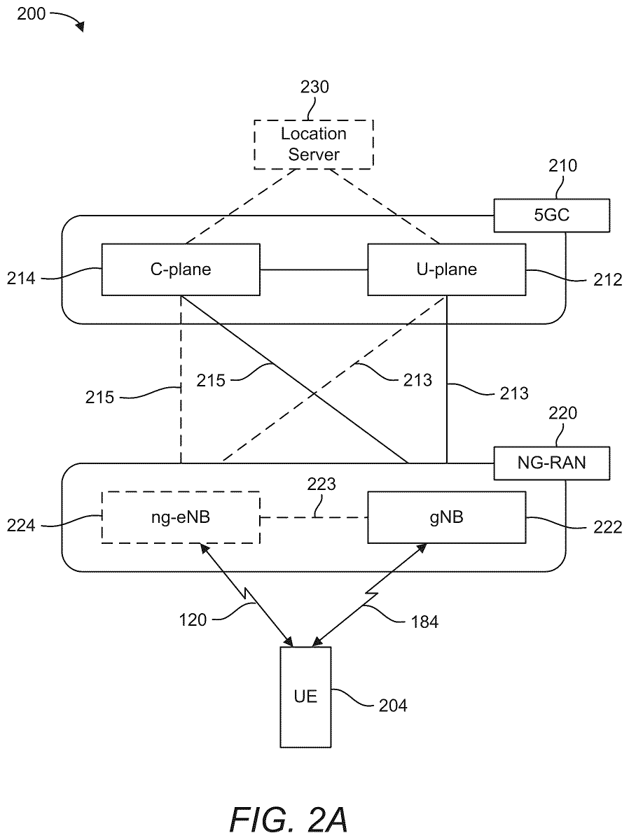

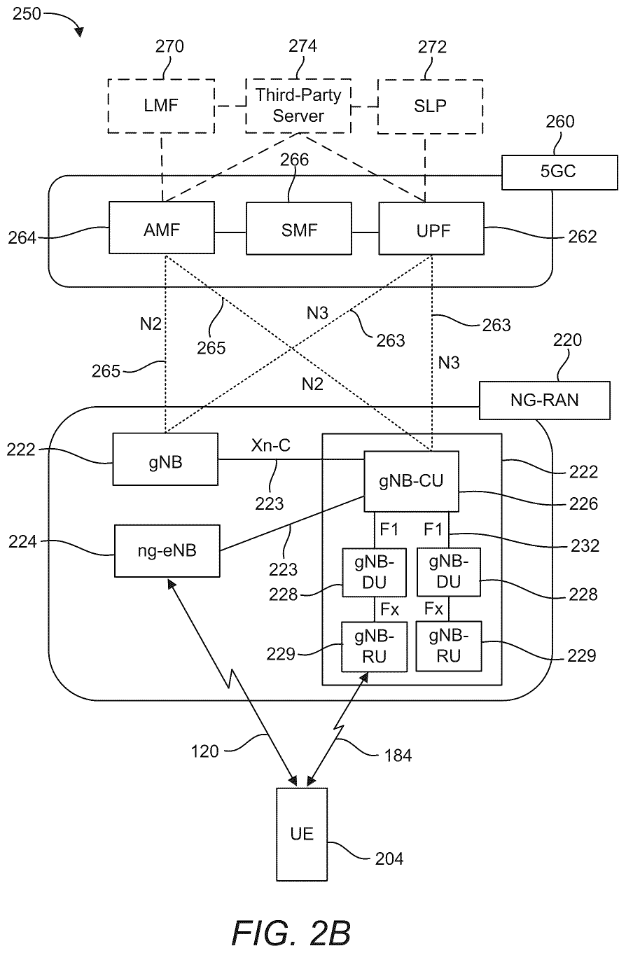

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management. UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the NII interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

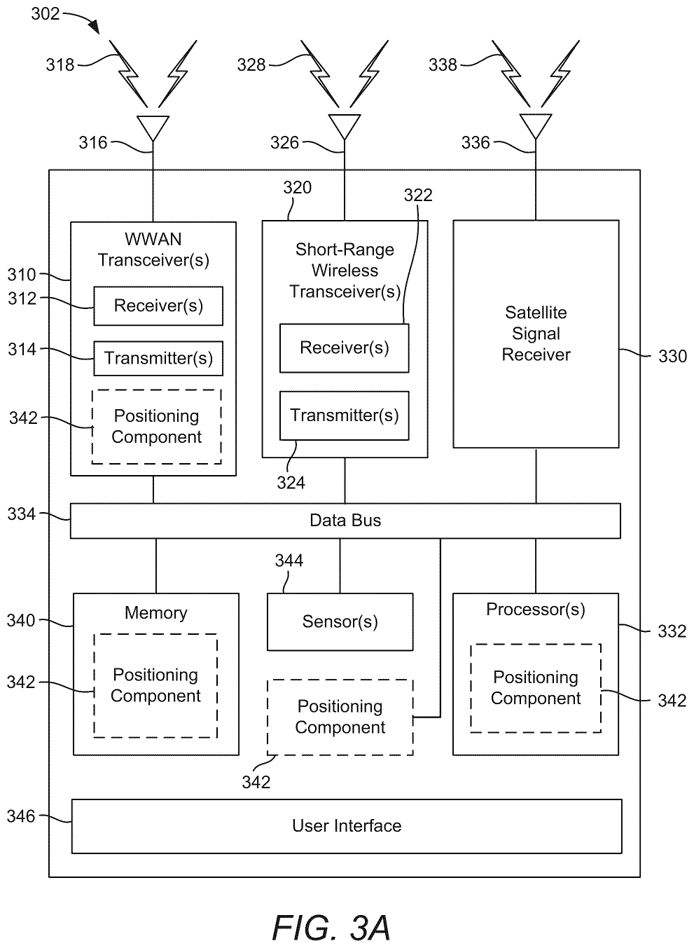

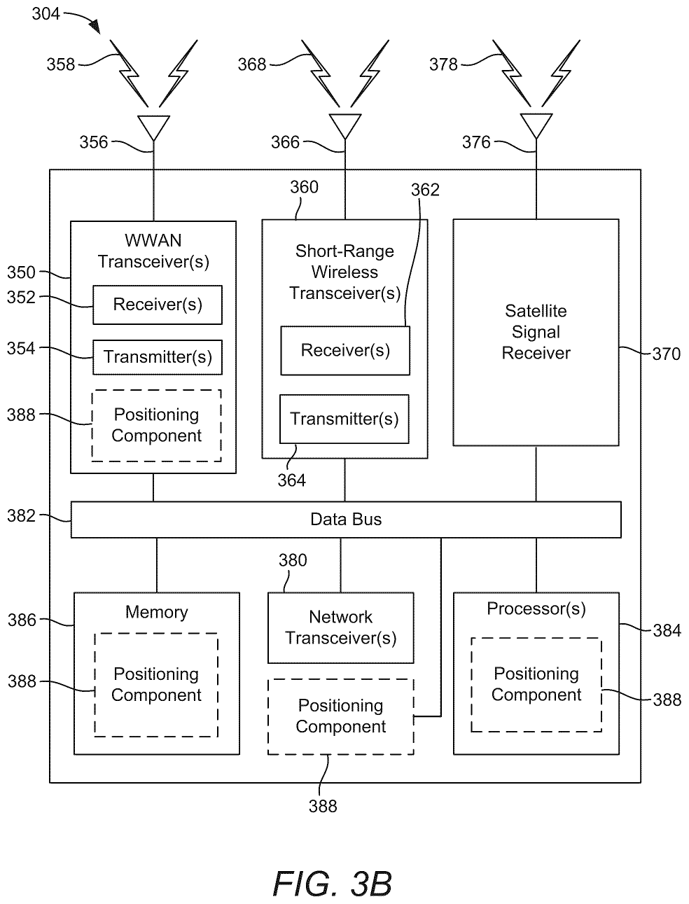

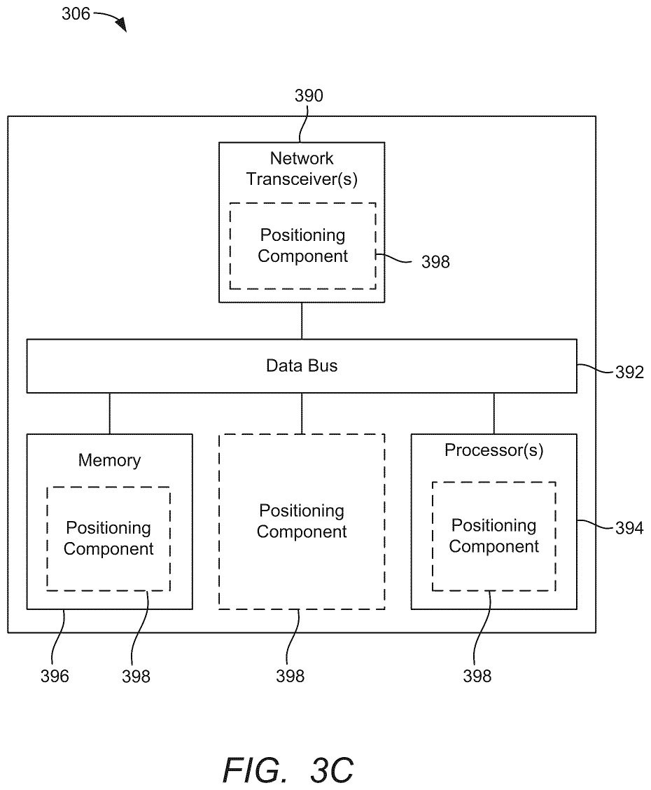

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR. LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals. Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

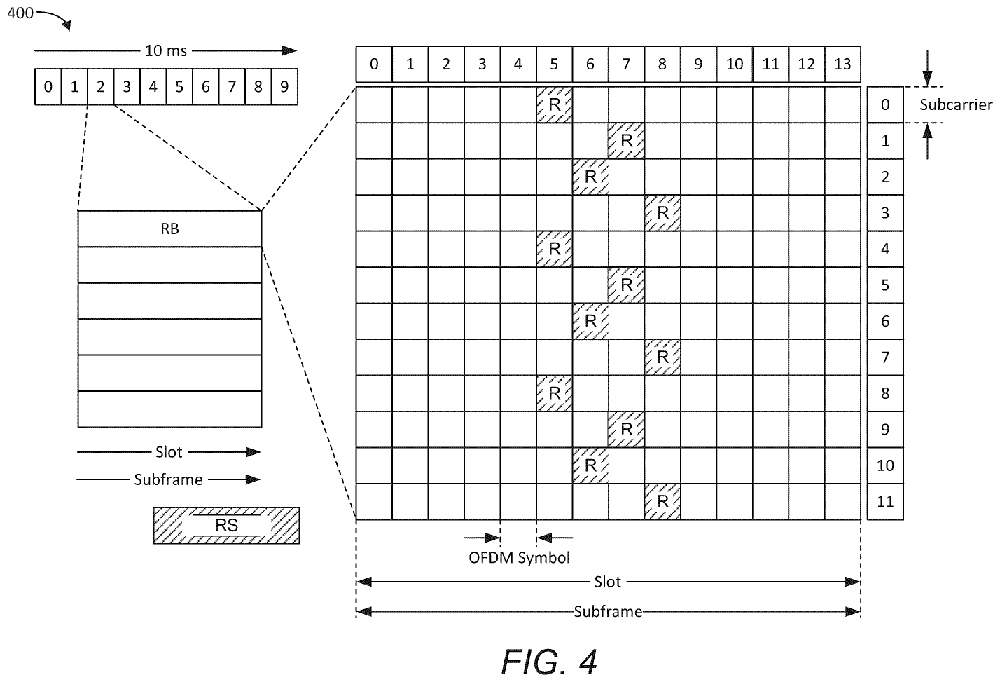

Various frame structures may be used to support downlink and uplink transmissions between network nodes (e.g., base stations and UEs). FIG. 4 is a diagram 400 illustrating an example frame structure, according to aspects of the disclosure. The frame structure may be a downlink or uplink frame structure. Other wireless communications technologies may have different frame structures and/or different channels.

LTE, and in some cases NR utilizes OFDM on the downlink and single-carrier frequency division multiplexing (SC-FDM) on the uplink. Unlike LTE, however. NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (p), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 kHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

A collection of resource elements (REs) that are used for transmission of PRS is referred to as a “PRS resource.” The collection of resource elements can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration. Specifically, for a comb size ‘N,’ PRS are transmitted in every Nth subcarrier of a symbol of a PRB. For example, for comb-4, for each symbol of the PRS resource configuration, REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS. FIG. 4 illustrates an example PRS resource configuration for comb-4 (which spans four symbols). That is, the locations of the shaded REs (labeled “R”) indicate a comb-4 PRS resource configuration.

Currently, a DL-PRS resource may span 2, 4, 6, or 12 consecutive symbols within a slot with a fully frequency-domain staggered pattern. A DL-PRS resource can be configured in any higher layer configured downlink or flexible (FL) symbol of a slot. There may be a constant energy per resource element (EPRE) for all REs of a given DL-PRS resource. The following are the frequency offsets from symbol to symbol for comb sizes 2, 4, 6, and 12 over 2, 4, 6, and 12 symbols. 2-symbol comb-2: {0, 1}; 4-symbol comb-2: {0, 1, 0, 1}; 6-symbol comb-2: {0, 1, 0, 1, 0, 1}; 12-symbol comb-2: {0, 1, 0, 1, 0, 1, 0, 1, 0, 1, 0, 1}; 4-symbol comb-4: {0, 2, 1, 3} (as in the example of FIG. 4); 12-symbol comb-4: {0, 2, 1, 3, 0, 2, 1, 3, 0, 2, 1, 3}; 6-symbol comb-6: {0, 3, 1, 4, 2, 5}; 12-symbol comb-6: {0, 3, 1, 4, 2, 5, 0, 3, 1, 4, 2, 5}; and 12-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2\hat{ }μ*{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource.” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion,” a “PRS positioning instance, a “positioning occasion,” “a positioning instance,” a “positioning repetition.” or simply an “occasion,” an “instance,” or a “repetition.”

A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the physical downlink shared channel (PDSCH) are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. If needed to further distinguish the type of PRS, a downlink positioning reference signal may be referred to as a “DL-PRS.” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

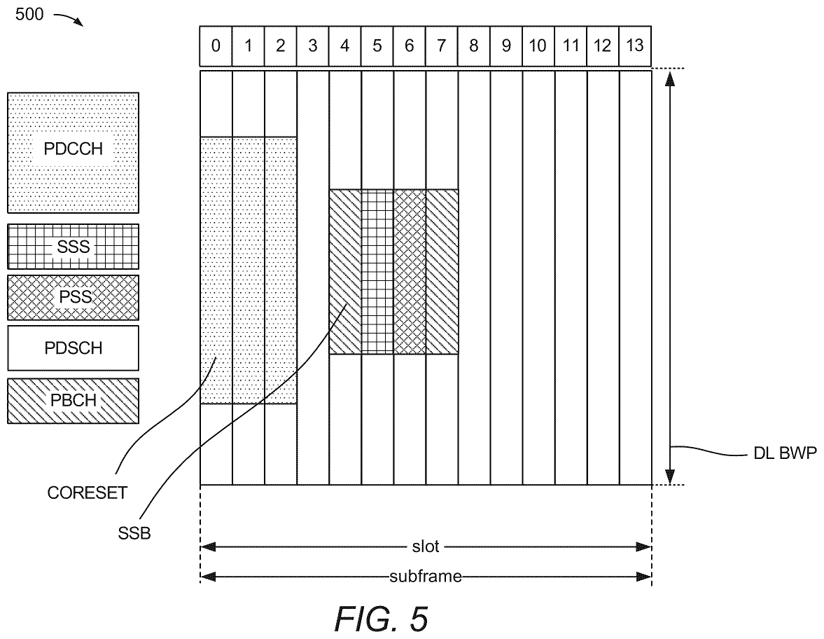

FIG. 5 is a diagram 500 illustrating various downlink channels within an example downlink slot. In FIG. 5, time is represented horizontally (on the X axis) with time increasing from left to right, while frequency is represented vertically (on the Y axis) with frequency increasing (or decreasing) from bottom to top. In the example of FIG. 5, a numerology of 15 kHz is used. Thus, in the time domain, the illustrated slot is one millisecond (ms) in length, divided into 14 symbols.

In NR, the channel bandwidth, or system bandwidth, is divided into multiple bandwidth parts (BWPs). A BWP is a contiguous set of RBs selected from a contiguous subset of the common RBs for a given numerology on a given carrier. Generally, a maximum of four BWPs can be specified in the downlink and uplink. That is, a UE can be configured with up to four BWPs on the downlink, and up to four BWPs on the uplink. Only one BWP (uplink or downlink) may be active at a given time, meaning the UE may only receive or transmit over one BWP at a time. On the downlink, the bandwidth of each BWP should be equal to or greater than the bandwidth of the SSB, but it may or may not contain the SSB.

Referring to FIG. 5, a primary synchronization signal (PSS) is used by a UE to determine subframe/symbol timing and a physical layer identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries a master information block (MIB), may be logically grouped with the PSS and SSS to form an SSB (also referred to as an SS/PBCH). The MIB provides a number of RBs in the downlink system bandwidth and a system frame number (SFN). The physical downlink shared channel (PDSCH) carries user data, broadcast system information not transmitted through the PBCH, such as system information blocks (SIBs), and paging messages.

The physical downlink control channel (PDCCH) carries downlink control information (DCI) within one or more control channel elements (CCEs), each CCE including one or more RE group (REG) bundles (which may span multiple symbols in the time domain), each REG bundle including one or more REGs, each REG corresponding to 12 resource elements (one resource block) in the frequency domain and one OFDM symbol in the time domain. The set of physical resources used to carry the PDCCH/DCI is referred to in NR as the control resource set (CORESET). In NR, a PDCCH is confined to a single CORESET and is transmitted with its own DMRS. This enables UE-specific beamforming for the PDCCH.

In the example of FIG. 5, there is one CORESET per BWP, and the CORESET spans three symbols (although it may be only one or two symbols) in the time domain. Unlike LTE control channels, which occupy the entire system bandwidth, in NR, PDCCH channels are localized to a specific region in the frequency domain (i.e., a CORESET). Thus, the frequency component of the PDCCH shown in FIG. 5 is illustrated as less than a single BWP in the frequency domain. Note that although the illustrated CORESET is contiguous in the frequency domain, it need not be. In addition, the CORESET may span less than three symbols in the time domain.

The DCI within the PDCCH carries information about uplink resource allocation (persistent and non-persistent) and descriptions about downlink data transmitted to the UE, referred to as uplink and downlink grants, respectively. More specifically, the DCI indicates the resources scheduled for the downlink data channel (e.g., PDSCH) and the uplink data channel (e.g., physical uplink shared channel (PUSCH)). Multiple (e.g., up to eight) DCIs can be configured in the PDCCH, and these DCIs can have one of multiple formats. For example, there are different DCI formats for uplink scheduling, for downlink scheduling, for uplink transmit power control (TPC), etc. A PDCCH may be transported by 1, 2, 4, 8, or 16 CCEs in order to accommodate different DCI payload sizes or coding rates.

The following are the currently supported DCI formats. Format 0-0: fallback for scheduling of PUSCH; Format 0-1: non-fallback for scheduling of PUSCH; Format 1-0: fallback for scheduling of PDSCH; Format 1-1: non-fallback for scheduling of PDSCH; Format 2-0: notifying a group of UEs of the slot format; Format 2-1: notifying a group of UEs of the PRB(s) and OFDM symbol(s) where the UEs may assume no transmissions are intended for the UEs; Format 2-2: transmission of TPC commands for PUCCH and PUSCH; and Format 2-3: transmission of a group of SRS requests and TPC commands for SRS transmissions. Note that a fallback format is a default scheduling option that has non-configurable fields and supports basic NR operations. In contrast, a non-fallback format is flexible to accommodate NR features.

As will be appreciated, a UE needs to be able to demodulate (also referred to as “decode”) the PDCCH in order to read the DCI, and thereby to obtain the scheduling of resources allocated to the UE on the PDSCH and PUSCH. If the UE fails to demodulate the PDCCH, then the UE will not know the locations of the PDSCH resources and it will keep attempting to demodulate the PDCCH using a different set of PDCCH candidates in subsequent PDCCH monitoring occasions. If the UE fails to demodulate the PDCCH after some number of attempts, the UE declares a radio link failure (RLF). To overcome PDCCH demodulation issues, search spaces are configured for efficient PDCCH detection and demodulation.

Generally, a UE does not attempt to demodulate each and very PDCCH candidate that may be scheduled in a slot. To reduce restrictions on the PDCCH scheduler, and at the same time to reduce the number of blind demodulation attempts by the UE, search spaces are configured. Search spaces are indicated by a set of contiguous CCEs that the UE is supposed to monitor for scheduling assignments/grants relating to a certain component carrier. There are two types of search spaces used for the PDCCH to control each component carrier, a common search space (CSS) and a UE-specific search space (USS).

A common search space is shared across all UEs, and a UE-specific search space is used per UE (i.e., a UE-specific search space is specific to a specific UE). For a common search space, a DCI cyclic redundancy check (CRC) is scrambled with a system information radio network temporary identifier (SI-RNTI), random access RNTI (RA-RNTI), temporary cell RNTI (TC-RNTI), paging RNTI (P-RNTI), interruption RNTI (INT-RNTI), slot format indication RNTI (SFI-RNTI), TPC-PUCCH-RNTI, TPC-PUSCH-RNTI, TPC-SRS-RNTI, cell RNTI (C-RNTI), or configured scheduling RNTI (CS-RNTI) for all common procedures. For a UE-specific search space, a DCI CRC is scrambled with a C-RNTI or CS-RNTI, as these are specifically targeted to individual UE.

A UE demodulates the PDCCH using the four UE-specific search space aggregation levels (1, 2, 4, and 8) and the two common search space aggregation levels (4 and 8). Specifically, for the UE-specific search spaces, aggregation level ‘1’ has six PDCCH candidates per slot and a size of six CCEs. Aggregation level ‘2’ has six PDCCH candidates per slot and a size of 12 CCEs. Aggregation level ‘4’ has two PDCCH candidates per slot and a size of eight CCEs. Aggregation level ‘8’ has two PDCCH candidates per slot and a size of 16 CCEs. For the common search spaces, aggregation level ‘4’ has four PDCCH candidates per slot and a size of 16 CCEs. Aggregation level ‘8’ has two PDCCH candidates per slot and a size of 16 CCEs.

Each search space comprises a group of consecutive CCEs that could be allocated to a PDCCH, referred to as a PDCCH candidate. A UE demodulates all of the PDCCH candidates in these two search spaces (USS and CSS) to discover the DCI for that UE. For example, the UE may demodulate the DCI to obtain the scheduled uplink grant information on the PUSCH and the downlink resources on the PDSCH. Note that the aggregation level is the number of REs of a CORESET that carry a PDCCH DCI message, and is expressed in terms of CCEs. There is a one-to-one mapping between the aggregation level and the number of CCEs per aggregation level. That is, for aggregation level ‘4,’ there are four CCEs. Thus, as shown above, if the aggregation level is ‘4’ and the number of PDCCH candidates in a slot is ‘2,’ then the size of the search space is ‘8’ (i.e., 4×2=8).

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR In an OTDOA or DL-TDOA positioning procedure, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RT and multi-RTT methods can be combined with other positioning techniques, such as UL-AoA and DL-AoD, to improve location accuracy.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

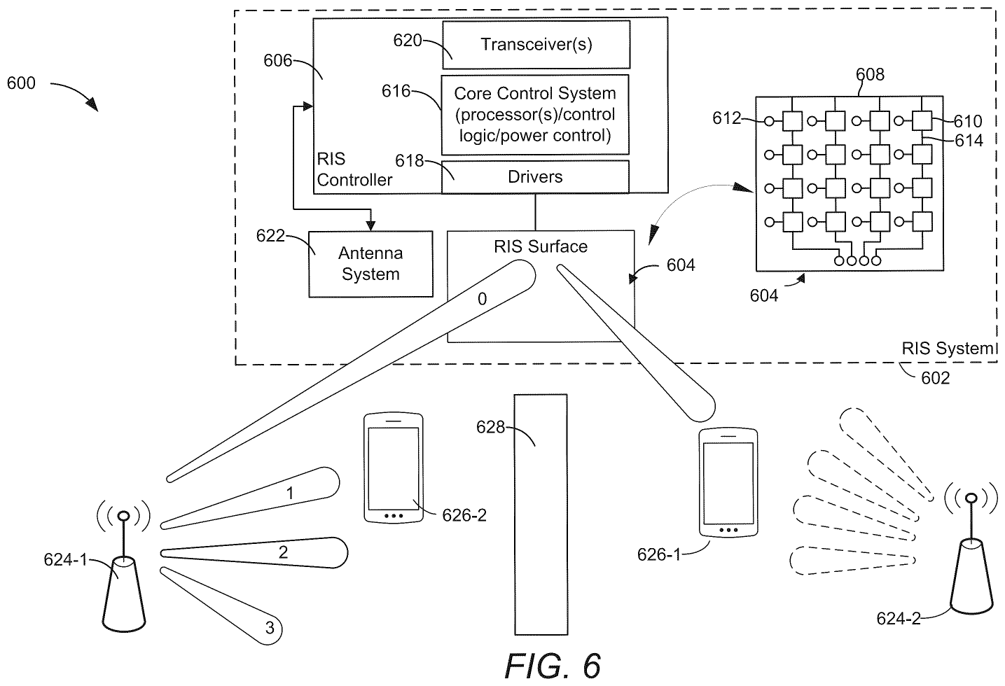

FIG. 6 illustrates an example system 600 for wireless communication using a reconfigurable intelligent surface (RIS) system 602, according to aspects of the disclosure. In the example shown in FIG. 6, the RIS system 602 includes a RIS surface 604 under the control of a RIS controller 606. The RIS surface 604 is a two-dimensional surface comprising a large number of low-cost, low-power, near-passive reflecting elements whose properties are reconfigurable (by software) rather than static. For example, by carefully tuning the phase shifts of the reflecting elements (using software), the scattering, absorption, reflection, and diffraction properties of a RIS can be changed over time. In that way, the electromagnetic (EM) properties of a RIS can be engineered to collect wireless signals from a transmitter (e.g., a base station, a UE, etc.) and passively beamform them towards a target receiver (e.g., another base station, another UE, etc.).

As shown in FIG. 6, the RIS surface 604 primarily consists of a planar surface 608 that may consist of three layers. In this case, the outer layer has a large number of reflecting elements 610 printed on a dielectric substrate to directly act on the incident signals. The middle layer is a copper panel to avoid signal/energy leakage. The last layer is a circuit board that is used for tuning the reflection coefficients of the reflecting elements 610 and is operated by the RIS controller 606. Each reflecting element 610 is coupled to a positive-intrinsic negative (PIN) diode 612. In addition, a biasing line 614 connects each reflecting element relay 10 in a column to the RIS controller 606. By controlling the voltage through the biasing line 614, the PIN diodes 612 can switch between ‘on’ and ‘off’ modes. This can realize a phase shift difference of π (pi) in radians. To increase the number of phase shift levels, more PIN diodes 612 can be coupled to each reflecting element 610.

In accordance with certain aspects of the disclosed system, the RIS controller 606 includes one or more processors, memory, control logic, and a power supply system, shown collectively as a core control system 616. In the example shown in FIG. 6, the RIS controller 606 includes drivers 618 that, under control of the core control system 616, drive the PIN diodes 612 of the RIS surface 604. In certain aspects, the RIS controller 606 also includes one or more transceivers 620 and a corresponding antenna system 622. In an aspect, the one or more transceivers 620 and antenna system 622 facilitate communication with network nodes, such as a first base station 624-1 and/or a second base station 624-2, either or both of which may control the RIS system 602 to “serve” (e.g., provide reflection services for) other network nodes, such as a first UE 626-1 and/or second UE 626-2. In an aspect, the antenna system 622 may be located proximate the RIS surface 604 to monitor the RF signal environment proximate the RIS surface 604.

In accordance with certain aspects of the disclosure, the optimal reflection coefficients of the RIS surface 604 are calculated at a base station (e.g., the base station 624-1 in FIG. 6) and then transmitted to the transceiver 620 of the RIS controller 606. In certain aspects, the optimal reflection coefficients may be communicated from the base station 624-1 to the RIS controller 606 over a dedicated feedback link (not shown).

In the example of FIG. 6, the RIS system 602 is controlled by the first base station 624-1, which controls the reflective properties of the RIS system 602 in order to communicate with UE 626-1. The goal of RIS technology is to create “smart” radio environments where the wireless propagation conditions are co-engineered with the physical layer signaling. This enhanced functionality of the system 600 can provide technical benefits in a number of scenarios.

In a first example scenario, as shown in FIG. 6, the first base station 624-1 (e.g., any of the base stations described herein) is attempting to transmit downlink wireless signals to the first UE 626-1 and the second UE 626-2 (e.g., any two of the UEs described herein, collectively, UEs 626) on a plurality of downlink transmit beams, labeled “0,” “1,” “2,” and “3.” However, unlike the second UE 626-2, because the first UE 626-1 is behind an obstacle 628 (e.g., a building, a hill, or another type of obstacle), it cannot receive the wireless signal on what would otherwise be the line-of-sight (LOS) beam from the first base station 624-1, that is, the downlink transmit beam labeled “2.” In this scenario, the first base station 624-1 may instead use the downlink transmit beam labeled “0” to transmit the wireless signal to the RIS surface 604, and configure the RIS system 602 to reflect/beamform the incoming wireless signal towards the first UE 626-1. The first base station 624-1 can thereby transmit the wireless signal around the obstacle 628.

Note that the first base station 624-1 may also configure the RIS system 602 for the first UE's 626-1 use in the uplink. In that case, the first base station 624-1 may configure the RIS system 602 to reflect an uplink signal from the first UE 626-1 to the first base station 624-1, thereby enabling the first UE 626-1 to transmit the uplink signal around the obstacle 628.

In another example scenario in which system 600 can provide a technical advantage, the first base station 624-1 may be aware that the obstacle 628 may create a “dead zone,” that is, a geographic area in which the downlink wireless signals from the first base station 624-1 are too attenuated to be reliably detected by a UE within that area (e.g., the first UE 626-1). In this scenario, the first base station 624-1 may configure the RIS system 602 to reflect downlink wireless signals into the dead zone in order to provide coverage to UEs that may be located there, including UEs about which the first base station 624-1 is not aware.

A RIS system (e.g., RIS system 602) may be designed to operate in either a first mode (referred to as “Mode 1”), in which the RIS system 602 operates as a reconfigurable mirror, or a second mode (referred to as “Mode 2”), in which the RIS system 602 operates as a receiver and transmitter (similar to the amplify and forward functionality of a relay node). Some RIS systems may be designed to operate in either Mode 1 or Mode 2, while other RIS systems may be designed to operate only in either Mode 1 or Mode 2. Mode 1 RIS systems are assumed to have a negligible hardware group delay, whereas Mode 2 RIS systems have a non-negligible hardware group delay due to limited baseband processing capability. In the example of FIG. 6, the RIS system 602 may be either a Mode 1 or Mode 2 RIS.

FIG. 6 also illustrates a second base station 624-2 that may transmit downlink wireless signals to one or both of the UEs 626. For example, the first base station 624-1 may be a serving base station for the UEs 626, and the second base station 624-2 may be a neighboring base station. The second base station 624-2 may transmit downlink positioning reference signals to one or both UEs 626 as part of a positioning procedure involving the UE(s) 626. Alternatively or additionally, the second base station 624-2 may be a secondary cell for one or both of the UEs 626. In some cases, the second base station 624-2 may also be able to reconfigure the RIS system 602, provided it is not controlled by the first base station 624-1 at the time.

Note that while FIG. 6 illustrates one RIS system 602 and one base station controlling the RIS system 602 (i.e., the first base station 624-1), the first base station 624-1 may control multiple RIS in the environment. In addition, the RIS system 602 may be controlled by multiple base stations 624 (e.g., both the first and second base stations 624-1 and 624-2, and possibly more).

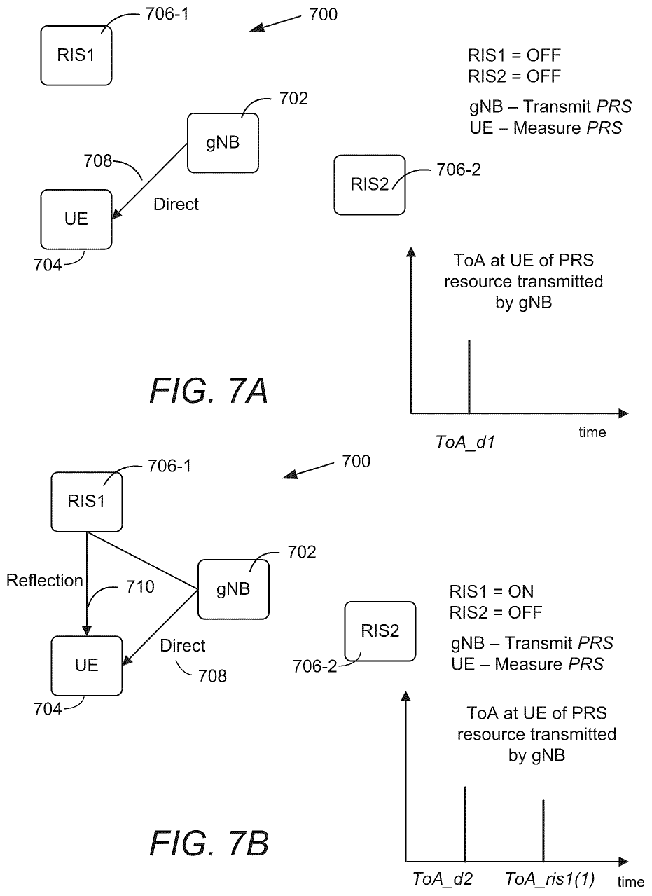

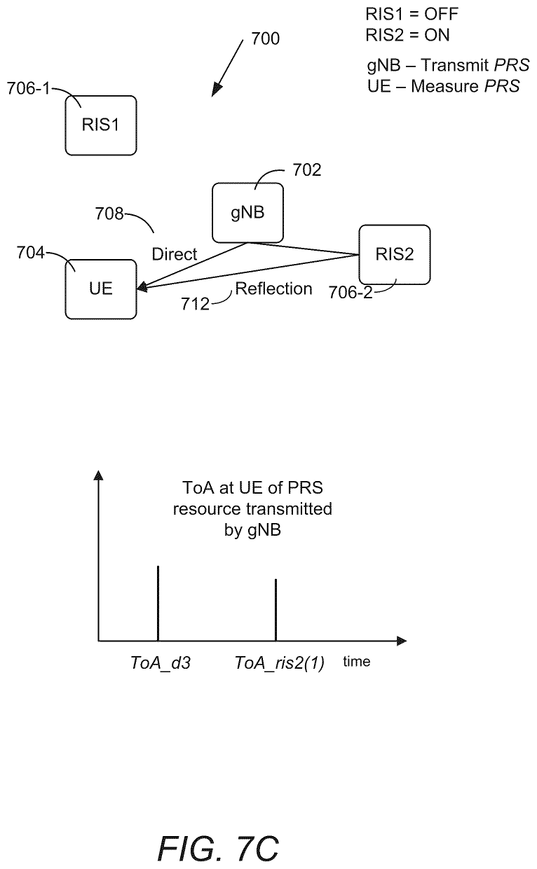

FIGS. 7A, 7B, and 7C (collectively. FIG. 7) show example positioning operations in accordance with certain aspects of the disclosure. In FIG. 7, the positioning environment 700 includes a gNB 702, a UE 704, and multiple RIS systems 706-1 and 706-2 (labeled “RIS1” and “RIS2”). In an aspect, the gNB 702 controls the activation and deactivation of the RIS systems 704-1 and 704-2.

In FIG. 7A, RIS1 706-1 and RIS2 706-1 are both deactivated when UE 704 requests that gNB 702 transmit PRS. During times when RIS1 706-1 and RIS2 706-2 are deactivated. UE 704 performs a ranging measurement of the PRS received from gNB 702 using direct LOS ToA. As shown in FIG. 7A, UE 704 receives the PRS transmission along a direct path 708 from the UE at TOA_{d1}. (The reference to TOA_{d1} is shown as TOA_d1 in FIG. 7A. In the figures, all characters following an “_” should be interpreted as subscripts and are noted as subscripts throughout the disclosure.)

In FIG. 7B, gNB 702 has deactivated RIS1 706-1, but RIS2 706-2 remains deactivated. Accordingly, the UE 704 receives the PRS along the direct path 708 at time ToA_{d2} and along a reflected path 710 from RIS1 706-1 at time ToAᵣᵢₛ₁₍₁₎. During instances when RIS1 706-1 is activated, the UE 704 performs ranging measurement of gNB 702 using the LOS ToA (ToA_{d2}) and the reflected path ToA (ToAᵣᵢₛ₁₍₁₎) from RIS1 706-1. In an aspect, UE 704 calculates the range to gNB 702 (R_{UE,gNB}) using the measurements ToA_{d1} and ToA_{d2}. Further, UE 704 calculates the range of the UE 704 to RIS1 (R_{UE2,RIS1}) by accounting for the range between gNB 702 and RIS1 706-1, as the positions of gNB 702 and RIS1 706-1 are typically known. Letting tₜₓ be the transmission time of the PRS by gNB 702, R_{gNB-RIS1}=(ToAᵣᵢₛ₁₍₁₎−tₜₓ)−∥p_{gNB}−p_{RIS1}∥/c, where p_{gNB}, p_{RIS1} are positions of gNB 702 and RIS1 706-2, respectively.

Additionally, or in the alternative, gNB 702 may deactivate RIS1 706-1 and deactivate RIS2 706-2, as shown in FIG. 7C. Here, the UE 704 receives the PRS along the direct path 708 at time ToA_{d3} and along a reflected path 712 from RIS2 706-2 at time ToAᵣᵢₛ₂₍₁₎. During times when RIS2 706-2 is activated, UE 704 performs a ranging measurement of gNB 702 using the LOS ToA (ToA_{d3}) and the reflected path ToA (ToAᵣᵢₛ₂₍₁₎) from RIS2 706-2. Similar methods as those described above can be used to calculate the range parameters with respect to RIS 706-2 given the absolute positions of gNB 702 and RIS2 706-2.

Although RIS may be advantageously used in a wide range of wireless communication environments, there are disadvantages to RIS use. With reference again to FIG. 6, if the RIS surface 604 is always in an activated, reflective state, unwanted transmissions may also be needlessly reflected to areas within the environment where such unwanted transmissions may interfere with other transmissions. For example, while the RIS surface 604 is in the activated state, transmissions from the second base station 624-2 may be reflected into the region served by the first base station 624-1, where the transmissions may undesirably interfere with communication between, for example, the first base station 624-1 and the second UE 626-2. Certain aspects of the disclosed system reduce such interference by reducing the amount of time that the RIS surface 604 is available to actively reflect undesirable transmissions.

Further, installation of a RIS system, such as RIS system 602, is accompanied by the need to provide electrical power to the site of the RIS system 602. Certain aspects of the disclosure reduce the power consumption needs of the RIS system to thereby reduce its cost of operation and its power supply requirements. To this end, certain aspects of the disclosure reduce the amount of time that the RIS controller 606 and/or RIS surface 604 are actively operating at full power.

Certain aspects of the disclosure provide autonomous solutions for reducing the amount of time that a RIS system is active and operating in a fully powered mode, as well as the amount of time that the RIS system is available for active reflection of signals of undesired signals. Additionally, certain aspects of the disclosure provide signaling solutions to achieve these goals.

In accordance with certain aspects of the disclosure, the RIS controller may transition from an idle state to an active state at certain times to perform channel sensing. The RIS controller performs channel sensing to determine whether there are active transmissions on one or more wireless communications channels worth reflecting by its RIS surface. For example, in a Uu link, the RIS controller can periodically sense for active transmissions from one or more network entities (e.g., UEs) that the RIS controller is configured to assist on the one or more wireless communications channels. One or more specified signal criteria may be applied to the active transmissions from the one or more network entities that the RIS controller is configured to assist to determine whether the RIS surface will transition from a deactivated state to an activated state in response to the active transmissions. Such specified criteria may include 1) an explicit indication to transition the RIS surface to the activated state, wherein the explicit indication is indicated in a received control signal or received data signal from or associated with the one or more network entities that the RIS controller is configured to assist, 2) the active transmissions received from the one or more network entities having a measured received signal strength indicator (RSSI) meeting an RSSI threshold, 3) the active transmissions received from the one or more network entities having a measured reference signal received power (RSRP) meeting an RSRP threshold, 4) the active transmissions received from the one or more network entities having a measured reference signal received quality (RSRQ) meeting an RSRQ threshold, 5) the active transmissions received from the one or more network entities having a measured angle of arrival (AoA) meeting an AoA threshold, or 6) any combination thereof. In an aspect, any of the foregoing measurements (RSSI, RSRP, RSRQ, AoA, or any combination thereof) may be compared to one or more measurements of the active transmissions, and the active transmissions include 1) DMRS, 2) DCI, 3) sidelink control information (SCI), 4) a PDSCH signal, 5) a physical sidelink shared channel (PSSCH) signal, or 6) any combination thereof. The RIS surface may be controlled so that it is activated only when the active transmissions meeting such specified criteria are detected, and deactivated when no signals meeting such specified criteria are detected. For more advanced RIS controllers, the RIS controller can decode the ongoing PDCCH and check if the signal is intended for its receiver.

Such selective activation of the RIS surface may also be implemented when a sidelink device, such as a UE, controls the RIS system. In sidelink (PC5) communications, for example, the RIS controller can participate in sensing the transmissions as needed based on sidelink control information (SCI) decoding. In an aspect, the RIS surface is only activated when signals received from a sidelink device defined in the SCI decoding meet one or more specified criteria (e.g., RSRP, RSRQ, RSSI, AoA, etc.).

In certain aspects, the RIS controller may operate in Mode 2 in which the RIS system operates as a receiver and transmitter. Based on the sensing results, assuming the RIS controller is performing Mode 2 sidelink sensing (e.g., the RIS controller reads the SCI then measures the RSRP), the RIS controller can determine if the network entity (e.g., UE) assisted by the RIS controller will have a retransmission or transmission in a next time slot. In an aspect, the RIS controller may activate the RIS surface during those time slot(s). The RIS surface may be activated with a RIS beamformer/configuration that is optimized to assist the intended transmission and reception network entities. In certain aspects, similar operations may take place in Uu, where the RIS controller reads the DCI and determines that the network entity is a network entity that the RIS controller is intended to serve based on an agreement with a base station (e.g., gNB).

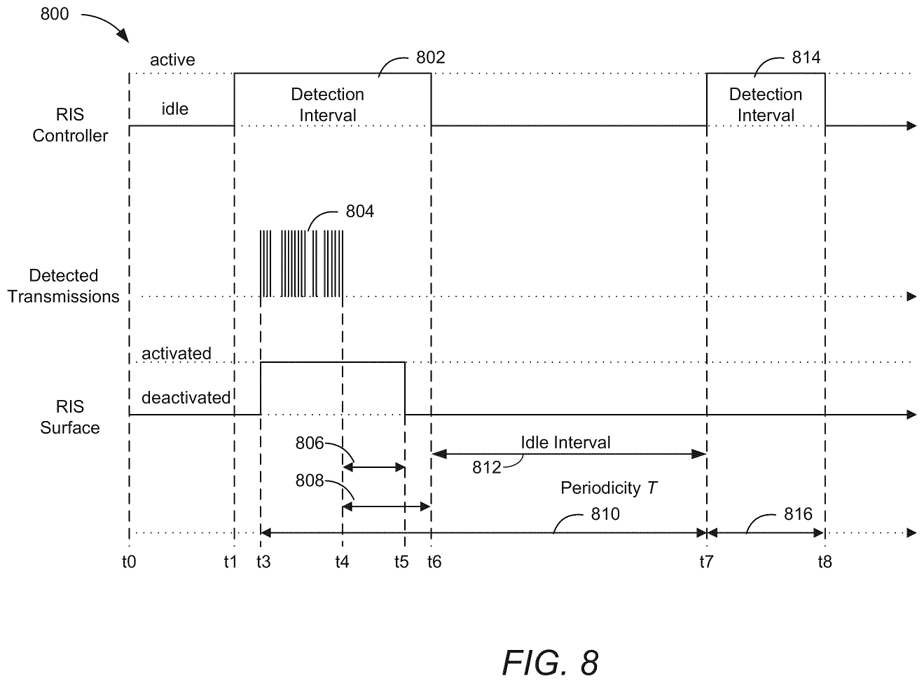

FIG. 8 is a timing diagram 800 showing an example of selectively activating a RIS controller and RIS surface in accordance with certain aspects of the disclosure. In this example, the RIS controller transitions from an idle state to an active state at the start of a detection interval 802. During the detection interval 802, the RIS controller performs one or more channel sensing operations to determine whether there are active transmissions on one or more wireless communications channels. Here, the RIS controller has started to detect transmissions 804 on a wireless channel at time t3.

In an aspect, the RIS controller determines whether the detected transmissions 804, as received by the RIS controller, meet one or more specified criteria (e.g., threshold RSSI measurement criteria, threshold RSRP measurement criteria, threshold RSRQ measurement criteria, specified AoA measurement criteria, etc.). In certain aspects, the specified criteria may be programmable and defined by the base station or sidelink device that controls the RIS system. To make the measurements of the detected transmissions 804 representative of the transmissions as they would be received at the RIS surface, the antenna(s) of the transceiver(s) of the RIS controller may be placed proximate the RIS surface. In the example shown in FIG. 8, the RIS controller has determined that the detected transmissions 804 meet one or more of the specified criteria and, in response, has transitioned the RIS surface from a deactivated state to an activated state allowing it to reflect the transmissions 804. In the activated state, the RIS controller provides signals to the elements of the RIS surface to cause the RIS surface to become directionally reflective.

In accordance with certain aspects of the disclosure, the RIS controller may return the RIS surface to the deactivated state at certain times when various conditions are met. In the deactivated state, the RIS controller turns off the elements of the RIS surface. Although the elements of the RIS surface are turned off in the deactivated state, the RIS surface may still nominally reflect or otherwise scatter signals but in a manner substantially different than in the activated state.

In accordance with certain aspects, the RIS surface is only in the activated state for a specified duration of time after the RIS surface has transitioned from the deactivated state to the activated state at time t3. In such instances, the RIS surface is deactivated once that specified duration has lapsed. In accordance with certain aspects, the RIS surface may be deactivated at a specified time after the transmissions 804 are no longer detected or otherwise no longer meet the specified criteria. In the example shown in FIG. 8, such active transmissions are no longer detected or no longer meet the specified criteria at time t4 and the RIS surface is deactivated at time t5, a specified interval 806 after the transmissions 804 are no longer detected or no longer meet the specified criteria.

Similarly, the RIS controller may return to an idle state under various conditions. In accordance with certain aspects, the RIS controller is only in the activated state for a specified duration of time after the RIS controller has transitioned from the idle state to the active state at time t1. In such instances, the RIS controller transitions back to the idle state once that specified duration has lapsed. In accordance with certain aspects, the RIS controller may be idle a specified duration of time after the transmissions 804 are no longer detected or no longer meet the specified criteria. In the example shown in FIG. 8, such detected transmissions are no longer detected or otherwise no longer meet the specified criteria at time t4, and the RIS controller goes to the idle state at time t6, a specified interval 808 after the transmissions 804 are no longer detected (e.g., the transmissions have ceased) or no longer meet the specified criteria.

In accordance with certain aspects of the disclosure, the RIS controller may transition from the idle state to the active state to execute channel sensing operations on a periodic basis. Periodic transitions are shown in FIG. 8, where the detection intervals occur with a periodicity T 810. Additionally, or in the alternative, the RIS controller may transition from the idle state to the active state at a specified time after the end of a prior detection interval, shown here as an idle interval 812. In the example shown in FIG. 8, the RIS controller transitions from the idle state to the active state at time t7 at the start of the next detection interval 814. Here, the RIS controller has not detected active transmissions during the detection interval 814 and returns to the idle state a specified time corresponding, for example, to a specified detection interval duration 816.

The timing and duration of the various intervals referenced in FIG. 8 may be defined by a controlling base station or controlling sidelink device and communicated therefrom to the RIS controller. In accordance with certain aspects of the disclosure, the RIS controller may provide the base station with certain preferred values for the periodicity of the detection interval. The controlling base station or controlling UE may select which value for the periodicity provided by the RIS controller will be used and communicate that value to the RIS controller for use. The detection interval corresponds to a sensing window when the RIS controller is controlled by one or more UEs over one or more sidelink channels. In certain aspects, the detection interval corresponds to a number of symbols, a number of sub-slots, a number of slots, a number of frames, a number of subframes, or any combination thereof, when the RIS controller is controlled by one or more base stations.

In certain aspects, the controlling base station or controlling UE may send detection interval parameters to the RIS controller. Such detection interval parameters may include information corresponding to a delay for the deactivation of the RIS surface after the active transmissions are no longer detected or no longer meet the threshold criteria (e.g., interval 806), a delay for returning the RIS controller to an idle state after the active transmissions are no longer detected or no longer meet the threshold criteria (e.g., interval 808), a duration of an idle interval (e.g., idle interval 812), the periodicity of the detection intervals (e.g., periodicity interval 810), a detection interval duration used when no qualifying signals are detected (e.g., interval 816), etc.

In an aspect, the detection interval parameters and the criteria for activating and/or deactivating the RIS surface may be programmable and provided to the RIS controller by the controlling base station or controlling sidelink device. When a base station, such as a gNB, controls the RIS system, the parameters may be received via radio resource control (RRC) signaling, downlink control information (DCI) signaling, medium access control (MAC) signaling, or any combination thereof. In an aspect, the detection interval parameters may correspond to a number of symbols, a number of sub-slots, a number of slots, a number of frames, a number of subframes, or any combination thereof.

When a sidelink device controls the RIS system, the parameters for the detection interval and the criterion for activating and/or deactivating the RIS surface may be received using sidelink control information (SCI) signaling, medium access control-control element (MAC-CE) signaling, or a combination thereof. In certain aspects, the parameters for the detection interval may include parameters for a sensing window indicating when the RIS controller is to go to the active state to detect active transmissions and subsequently return to the idle state. Similarly, the specified criterion for determining whether an active transmission will cause the RIS surface to transition from the deactivated state to the activated state may also be defined in such an exchange.

To ensure that the foregoing operation of the RIS system does not interfere with other tasks, such as positioning operations, the RIS controller may send announcements to the controlling base station or sidelink device, where the announcements are indicative of when the RIS controller transitions or is scheduled to transition between the idle/active states and active/idle states. Similarly, the RIS controller may send further announcements to the controlling base station or controlling sidelink, where the further announcements are indicative of when the RIS surface transitions or is scheduled to transition between the deactivated/activated states and activated/deactivated states. In an aspect, the announcements may be sent to a controlling base station using (RRC) signaling, DCI signaling, MAC signaling, or any combination thereof. When a sidelink device controls the RIS system, the announcement may be sent using sidelink control information (SCI) signaling, medium access control-control element (MAC-CE) signaling, or a combination thereof.

A variety of timing and content may be used in the announcements. In an aspect, the announcement may be sent at a time proximate to the time at which the transition took place or is scheduled to take place. Additionally, or in the alternative, the announcement may indicate the time at which the transition took place or is scheduled to take place. In an aspect, the announcement may indicate the type of transition that took place or is scheduled to take place (e.g., idle-to-active, deactivated-to-activated, active-to-idle, activated-to-deactivated).

With reference to FIG. 8, the RIS controller may send an announcement indicating that the RIS controller has transitioned from the idle state to the active state at time t1. The RIS controller may send another announcement indicating that the RIS controller has driven the RIS surface from the deactivated state to the activated state at time t3. The RIS controller may send another announcement indicating that the RIS surface has been transitioned to the deactivated state at time t5. Further, the RIS controller may send an announcement indicating that it is about to transition from the active state to the idle state at time t6. The RIS controller may transmit similar announcement messages with respect to the detection interval 814, although there is no need to indicate an activation of the RIS surface since the RIS surface is not activated during the detection interval 814. In certain aspects, the controlling base station and/or controlling sidelink device may relay the states of the RIS controller and/or RIS surface to other network nodes (e.g., other base stations, UEs, etc.) in the radio environment so that the other network nodes are aware of the RIS system state when conducting their own tasks, such as positioning determinations.

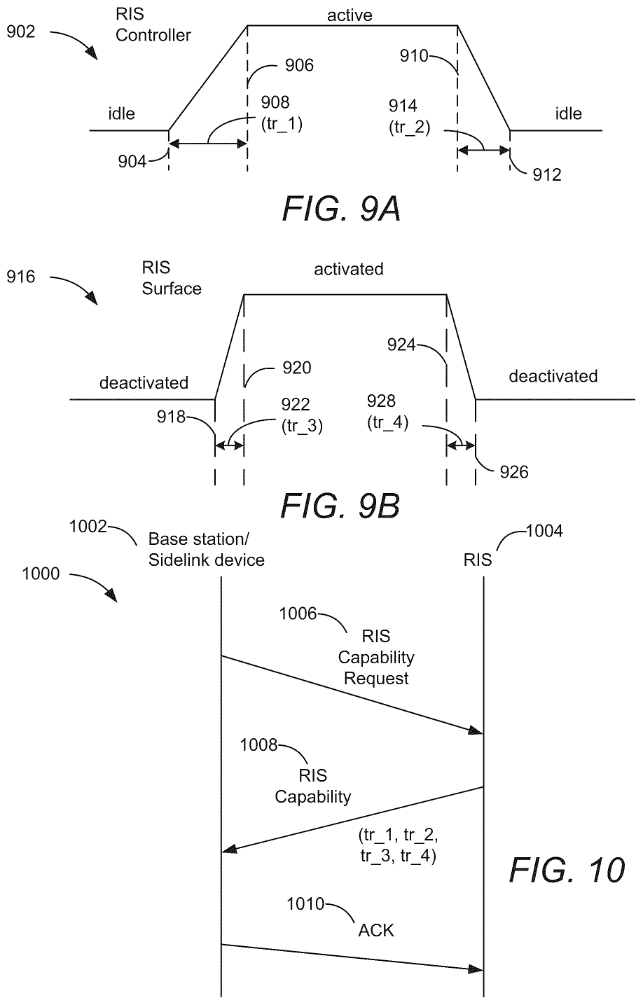

In accordance with certain aspects of the disclosure, the RIS controller may indicate its transitioning time capabilities to a controlling base station and/or controlling sidelink device. FIGS. 9A and 9B (collectively “FIG. 9”) are timing diagrams depicting transitioning time capabilities in accordance with certain aspects of the disclosure.

FIG. 9A is a timing diagram 902 showing an example of the transitioning time capabilities of a RIS controller in accordance with certain aspects of the disclosure. In this example, the RIS controller is directed (e.g., triggered by a timer, interrupt, etc.) to transition from the idle state to the active state at time 904. In practice, the RIS controller takes a finite amount of time to transition from the idle state to the active state. Here, the RIS controller is fully transitioned to the active state at time 906 over a transition time tr₁ 908. In this example, transition time tr₁ 908 corresponds to the transition time capability of the RIS controller to go from the idle state to the active state. At time 910, the RIS controller is directed to transition from the active state to the idle state. Again, the RIS controller takes a finite amount of time to make this transition. Here, the RIS controller is fully transitioned to the idle state at time 912 over a transition time tr₂ 914. In this example, transition time tr₂ 914 corresponds to the transition time capability of the RIS controller to go from the active state to the idle state.

In certain aspects, the indicated transitioning time capabilities of the RIS controller may be indicated with further RIS controller parameters. In an aspect, the RIS controller transitioning time capabilities may be indicated based on 1) a frequency band served by the RIS controller, 2) a frequency band combination served by the RIS controller, 3) a carrier served by the RIS controller, 4) a carrier combination served by the RIS controller, or 5) any combination thereof.

FIG. 9B is a timing diagram 916 showing an example of the transitioning time capabilities of a RIS surface in accordance with certain aspects of the disclosure. In this example, the RIS controller controls the RIS surface to transition from the deactivated state to the activated state at time 918. As a practical matter, the RIS surface takes a finite amount of time to transition from the deactivated state to the activated state. Here, the RIS surface is fully transitioned to the activated state at time 920 over a transition time tr₃ 922. In this example, transition time tr₃ 922 corresponds to the transition time capability of the RIS surface to go from the deactivated state to the activated state. At time 924, the RIS controller controls the RIS surface to transition from the activated state to the deactivated state. Again, the RIS surface takes a finite amount of time to make this transition. Here, the RIS surface is fully transitioned to the deactivated state at time 926 over a transition time tr₄ 928. In this example, transition time tr₄ 928 corresponds to the transition time capability of the RIS surface to go from the activated state to the deactivated state.

In certain aspects, the indicated transitioning time capabilities of the RIS surface may be indicated with further RIS surface parameters. In an aspect, the RIS surface transitioning time capabilities may be indicated based on 1) a frequency band reflected by the RIS surface, 2) a frequency band combination reflected by the RIS surface, 3) a carrier reflected by the RIS surface, 4) a carrier combination reflected by the RIS surface, or 5) any combination thereof.

In accordance with certain aspects of the disclosure, the RIS controller may transition between multiple active states. The transition times between such active states may also be indicated as part of the transitioning capabilities of the RIS controller. Similarly, the RIS surface may transition between multiple activated states. In certain aspects, the transition time between the active states may be zero. The transition times between such activated states may also be indicated as part of the transitioning capabilities of the RIS surface. In certain aspects, the transition time between the activated states may be zero.

FIG. 10 is an example of a call flow 1000 that may take place between a RIS system 1004 and a controlling base station or controlling sidelink device 1002 to indicate the transitioning time capabilities of the RIS system. In this example, the controlling base station/sidelink device 1002 sends a RIS capability request message 1006 to the RIS system 1004. In an aspect, the RIS system 1004 responds with a RIS capability message 1008 indicating the transition time capabilities (tr₁, tr₂, tr₃, tr₄) of the RIS system 1004. In certain aspects, the controlling base station/sidelink device 1002 may optionally respond with an acknowledgment (ACK) message 1010 indicating that the transitioning time capabilities were successfully received. In certain aspects, the transitioning time capability exchange may take place using one or more of RRC signaling, DCI signaling. MAC signaling, MAC-E signaling, and/or SCI signaling. In certain aspects, the transition time capabilities of the RIS system 1004 may be relayed to other network nodes so that the other network nodes can use the transition capability information along with any RIS controller and/or surface state information to more accurately determine the current state of the RIS system.

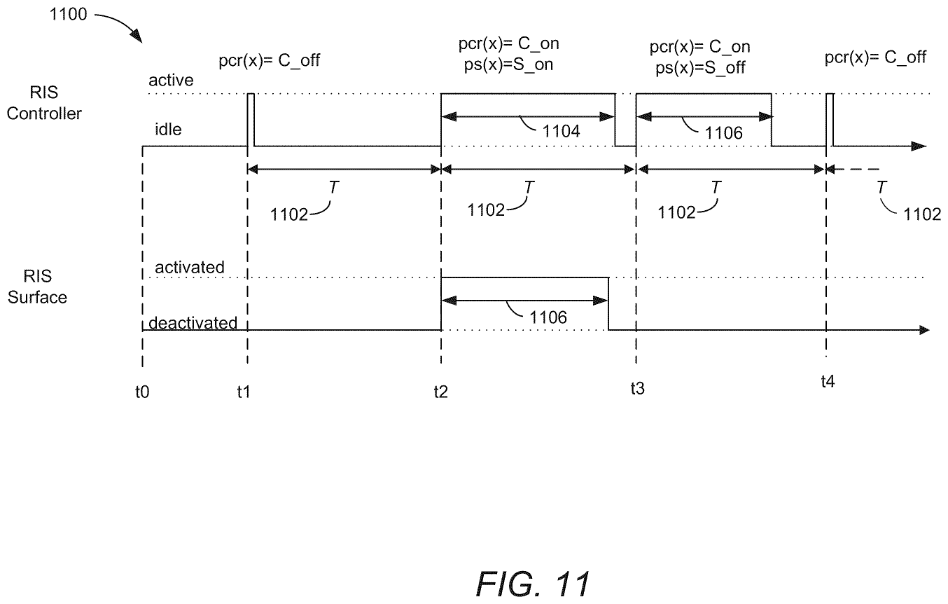

In accordance with certain aspects of the disclosure, the RIS controller may transition between the idle and active states, and drive the RIS surface between the activated and deactivated states in a probabilistic manner. An example of how the RIS controller may probabilistically switch between such states is shown in the timing diagram 1100 of FIG. 11.

In the example shown in FIG. 11, the RIS controller applies a first probability function pcr(x) in determining whether the RIS controller is to be in the idle state (pcr(x)=C_{off}) or active state (pcr(x)=Cₒₙ) and takes the corresponding actions to place the RIS controller in the appropriate state based on the outcome of the first probability function pcr(x). If the RIS controller is placed in the active state (e.g., pcr(x)=Cₒₙ), the RIS controller may apply a second probability function ps(x) in determining whether the RIS surface is to remain in the deactivated state (ps(x)=S_{off}) or placed in the activated state (ps(x)=Sₒₙ) during the time in which the RIS controller is in the active state. In certain aspects, the first and second probability functions, pcr(x) and ps(x), and/or parameters to be used in the first and second probability functions, pcr(x) and ps(x), may be provided to the RIS controller by the controlling base station or controlling sidelink device. In certain aspects, the first and second probability functions, pcr(x) and ps(x) may employ a prediction method in which the probability functions are formulated based on whether the active transmissions detected by the RIS controller have a pattern. In certain aspects, the RIS controller can send the best timing parameters for the activation and deactivation of the RIS surface (and, in certain aspects, the best timing parameters for the idle and active modes of the RIS controller) to the base station, which can ultimately decide on which timing parameters are to be used based on network performance.

In certain aspects, the probability function pcr(x)(or, conversely, 1−pcr(x)) may be selected to ensure that the RIS controller is active and/or idle for a certain amount of time over a larger time frame even though the specific times at which the RIS controller is active and/or idle over the larger time frame is probabilistic. In certain aspects, the probability function pcr(x) (or, conversely, 1−pcr(x)) may be selected to ensure that the RIS controller is active and/or idle at a certain time with a specified probability. In certain aspects, the probability function pcr(x) (or, conversely, 1−pcr(x)) may be selected from a set of probability functions defined in a standard, such as a 3GPP standard. In certain aspects, the probability function pcr(x) may consider the outcomes of prior applications of the probability function pcr(x) and/or a historical record of the idle and/or active states in determining the current outcome of the probability function pcr(x).

In certain aspects, the probability function ps(x) (or, conversely, 1−pcr(x)) may be selected to ensure that the RIS surface is activated and/or deactivated for a certain amount of time over a larger time frame even though the specific times at which the RIS surface is active and/or deactivated over the larger time frame is probabilistic. In certain aspects, the probability function ps(x) (or, conversely, 1−ps(x)) may be selected to ensure that the RIS surface is activated and/or deactivated at a certain time with a specified probability. In certain aspects, the probability function ps(x) (or, conversely, 1−ps(x)) may be selected from a set of probability functions defined in a standard, such as a 3GPP standard. In certain aspects, the probability function ps(x) may consider the outcomes of prior applications of the probability function ps(x) and/or a historical record of the activated and/or deactivated states in determining the current outcome of the probability function ps(x).

In the example shown in FIG. 11, the RIS controller transitions to or remains in the active state based on a first outcome of the first probability function, and transitions to or remains in the idle state based on a second outcome of the first probability function. In certain aspects, the RIS controller transitions from the idle state to the active state to apply and determine the outcome of the probability function. Additionally, or in the alternative, depending on the processing resources available to the RIS controller while in the idle state, the RIS controller may apply and determine the outcome of the probability function while in the idle state.

In the example shown in FIG. 11, the RIS controller transitions to the active state (or remains in an idle state in which it can process certain calculations) at the time t1 and applies the first probability function pcr(x) to determine whether the RIS controller is to remain in the active state or return to the idle state during the current cycle. In this example, the outcome of the first probability function is pcr(x)=C_{off}, indicating that the RIS controller is to immediately return to the idle state for this cycle. In certain aspects, the cycle for applying the first probability function pcr(x) may be periodic with a time period T 1102 defining the time between cycles. Accordingly, at the time t2, the RIS controller again transitions from the idle state to the active state and applies the first probability function pcr(x) to determine whether the RIS controller will remain in the active state or return to the idle state. In this example, the outcome of the first probability function at the time t2 is pcr(x)=Cₒₙ, indicating that the RIS controller is to remain in the active state. The duration 1104 over which the RIS controller remains active may be a static value (e.g., a fixed value known to the RIS controller, a value provided by a controlling base station, a value provided by a sidelink device, etc.) or a value determined from the application of a probability function (e.g., pcr(x)).

In certain aspects, the RIS controller applies the second probability function ps(x) to determine whether the RIS surface is to be activated or remain deactivated while the RIS controller is in the active state. In the example of FIG. 11, the outcome of the second probability function is ps(x)=Sₒₙ, indicating that the RIS controller is to place the RIS surface in the activated state. The interval 1106 over which the RIS surface remains in the activated state may be a static value (e.g., a value known to the RIS controller as part of a standard, a value provided by a controlling base station, a value provided by a sidelink device, etc.) or a value determined from the application of a probability function (e.g., pcr(x)).

Upon expiration of the interval 1106, or in response to other conditions ascertained by the RIS controller, the RIS surface transitions from the activated state to the deactivated state. Similarly, upon expiration of the duration 1104, or in response to other conditions ascertained by the RIS controller, the RIS controller transitions from the active state to the idle state.

At time t3, the RIS controller again transitions from the idle state to the active state and applies the probability function pcr(x) to determine whether the RIS controller will remain in the active state or otherwise transition immediately to the idle state. Here, the outcome of the first probability function is pcr(x)=Cₒₙ, indicating that the RIS controller is to remain in the active state, at least for a duration 1108. The RIS controller also applies the second probability function ps(x) to determine whether the RIS surface is to be activated. Here, the outcome of the second probability function is ps(x)=S_{off}, indicating that the RIS surface will not be activated during interval 1106. In accordance with certain aspects of the disclosure, however, the RIS controller may operate in the manner shown and described in connection with FIG. 8 and activate the RIS surface if the RIS controller detects active transmissions on one or more wireless channels. If active transmissions are detected, the RIS controller may activate/deactivate the RIS surface and transition between the active and idle state as described herein with reference to FIG. 8.

The RIS controller returns to the idle state after the expiration of time interval 1106 (or in response to other criteria ascertained by the RIS controller). At time t4, the RIS controller again goes from the idle state to the active state to apply the first probability function pcr(x). At time t4, the outcome of the first probability function is pcr(x)=C_{off}, indicating that the RIS controller is to immediately return to the idle state until the next cycle (e.g., after the lapse of the following time period 7).

The timing parameters associated with the timing diagram 1100 may be provided by the controlling base station or controlling sidelink device using one or more of RRC signaling, DCI signaling, MAC signaling, MAC-CE signaling, and/or SCI signaling. As in the example shown in FIG. 8, the RIS controller may indicate the times when the RIS controller goes from the idle state to the active state and from the active state to the idle state. Likewise, the RIS controller may indicate when the RIS surface goes from the deactivated state to the activated state and from the activated state to the deactivated state. Again, signaling of these transitions may occur using one or more of the foregoing signaling mechanisms. In accordance with certain aspects of the disclosure, the timing parameters may correspond to a number of symbols, a number of sub-slots, a number of slots, a number of frames, a number of subframes, a sensing window, or any combination thereof

In certain aspects, the RIS controller can assist in inter-device sensing coordination in sidelink communications where the RIS controller can send some resource sensing information. In certain aspects, the sensing and access probability functions, the duration for which the RIS surface remains in the activated state, and/or durations for during which the RIS controller remains in the active state performing channel sensing may be optimized based on average performance and additional factors. In certain aspects, the base station (e.g., gNB) or monitoring UE (e.g., in PC5 communications) can assist the RIS controller to optimize such parameters based on 1) transmissions quality and priority, 2) channel busy ratio (CBR), 3) channel occupancy ratio (CR), 4) the number of RIS operating in the network, or 5) any combination thereof.

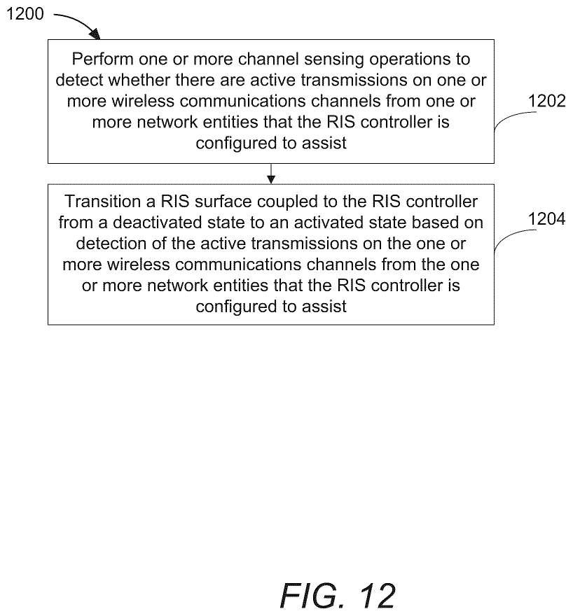

FIG. 12 illustrates an example method 1200 of wireless communication performed by a reconfigurable intelligent surface (RIS) controller, according to aspects of the disclosure. At operation 1202, the RIS controller performs one or more channel sensing operations to detect whether there are active transmissions on one or more wireless communications channels from one or more network entities that the RIS controller is configured to assist. In an aspect, operation 1202 may be performed by the one or more transceivers 620, one or more components of core control system 616, and drivers 618, any or all of which may be considered means for performing this operation.

At operation 1204, the RIS controller transitions a RIS surface coupled to the RIS controller from a deactivated state to an activated state based on detection of the active transmissions on the one or more wireless communications channels from the one or more network entities that the RIS controller is configured to assist. In an aspect, operation 1204 may be performed by the one or more transceivers 620, one or more components of core control system 616, and drivers 618, any or all of which may be considered means for performing this operation.

As will be appreciated, a technical advantage of the method 1200 is that the RIS surface is only activated for limited amounts of time thereby rendering the RIS system more power efficient.

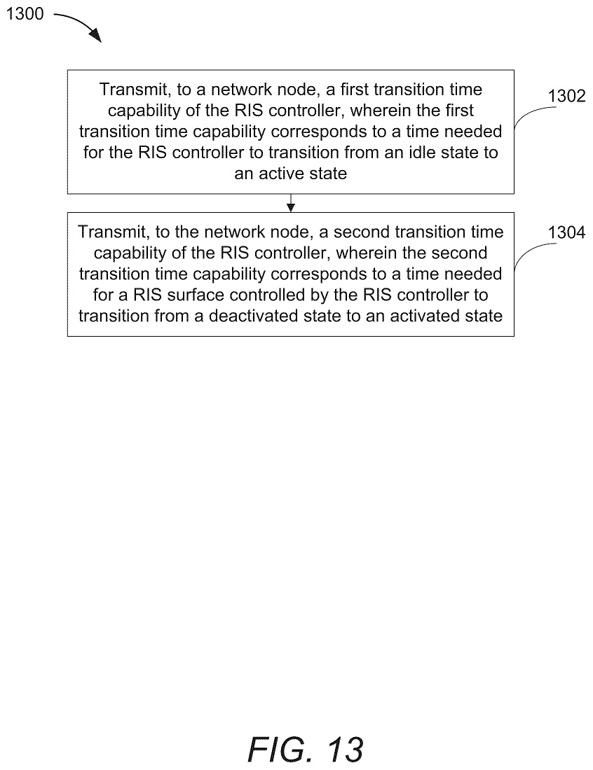

FIG. 13 illustrates an example method 1300 of wireless communication performed by a reconfigurable intelligent surface (RIS) controller communication, according to aspects of the disclosure. At operation 1302, the RIS controller transmits, to a network node, a first transition time capability of the RIS controller, wherein the first transition time capability corresponds to a time needed for the RIS controller to transition from an idle state to an active state. In an aspect, operation 1302 may be performed by the one or more transceivers 620, one or more components of core control system 616, and drivers 618, any or all of which may be considered means for performing this operation.

At operation 1304, the RIS controller transmits, to the network node, a second transition time capability of the RIS controller, wherein the second transition time capability corresponds to a time needed for a RIS surface controlled by the RIS controller to transition from a deactivated state to an active state. In an aspect, operation 1304 may be performed by the one or more transceivers 620, one or more components of core control system 616, and drivers 618, any or all of which may be considered means for performing this operation.

As will be appreciated, a technical advantage of the method 1300 is that network nodes can use the transition capability information along with any RIS controller and/or surface state information to accurately determine the current state of the RIS system. As such, the network nodes may execute tasks, such as positioning operations, with knowledge of the idle/active/activated/deactivated state of the RIS system thereby allowing the network nodes to consider the state of the RIS system while executing such tasks.

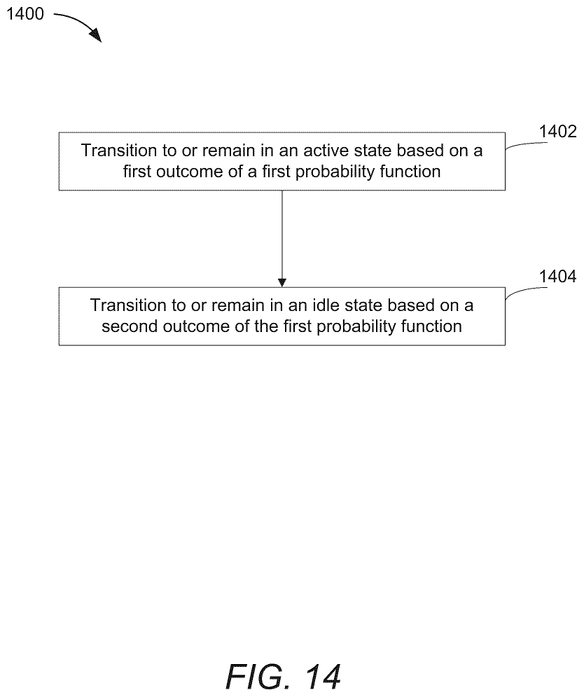

FIG. 14 illustrates an example method 1400 of wireless communication performed by a reconfigurable intelligent surface (RIS) controller communication, according to aspects of the disclosure. At operation 1402, the RIS controller transitions to or remains in an active state based on a first outcome of a first probability function. In an aspect, operation 1402 may be performed by the one or more transceivers 620, one or more components of core control system 616, and drivers 618, any or all of which may be considered means for performing this operation.

At operation 1404, the RIS controller transitions to or remains in an idle state based on a second outcome of the first probability function. In an aspect, operation 1404 may be performed by the one or more transceivers 620, one or more components of core control system 616, and drivers 618, any or all of which may be considered means for performing this operation.

As will be appreciated, a technical advantage of the method 1400 is that the RIS surface is only activated for limited amounts of time thereby reducing the time during which undesired signals are reflected by the RIS surface. Additionally, both the RIS surface and RIS controller are only activated for limited amounts of time thereby rendering the RIS system more power efficient.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a reconfigurable intelligent surface (RIS) controller, comprising: performing one or more channel sensing operations to detect whether there are active transmissions on one or more wireless communications channels from one or more network entities that the RIS controller is configured to assist; and transitioning a RIS surface coupled to the RIS controller from a deactivated state to an activated state based on detection of the active transmissions on the one or more wireless communications channels from the one or more network entities that the RIS controller is configured to assist.

Clause 2. The method of clause 1, further comprising: determining whether the active transmissions are from the one or more network entities that the RIS controller is configured to assist by decoding physical downlink control channels (PDCCH) received from the one or more network entities.

Clause 3. The method of any of clauses 1 to 2, wherein: the RIS surface is transitioned to the activated state based on the active transmissions detected on the one or more wireless communications channels meeting a specified criterion.

Clause 4. The method of clause 3, wherein the specified criterion comprises: an explicit indication to transition the RIS surface to the activated state, wherein the explicit indication is indicated in a received control signal or received data signal from or associated with the one or more network entities that the RIS controller is configured to assist; the active transmissions received from the one or more network entities having a measured received signal strength indicator (RSSI) meeting an RSSI threshold; the active transmissions received from the one or more network entities having a measured reference signal received power (RSRP) meeting an RSRP threshold; the active transmissions received from the one or more network entities having a measured reference signal received quality (RSRQ) meeting an RSRQ threshold; the active transmissions received from the one or more network entities having a measured angle of arrival (AoA) meeting an AoA threshold; or any combination thereof.

Clause 5. The method of clause 4, wherein: the RSSI threshold, the RSRP threshold, the RSRQ threshold, the AoA threshold, or any combination thereof is compared to one or more measurements of the active transmissions, and the active transmissions comprise: demodulation reference signals (DMRS), downlink control information (DCI), sidelink control information (SCI), a physical downlink shared channel (PDSCH) signal, a physical sidelink shared channel (PSSCH) signal, or any combination thereof.

Clause 6. The method of any of clauses 1 to 5, wherein: the one or more channel sensing operations are performed during a detection interval, and the detection interval corresponds to a number of symbols, a number of sub-slots, a number of slots, a number of frames, a number of subframes, a number of milliseconds, a sensing window, or any combination thereof.

Clause 7. The method of clause 6, further comprising: transitioning to an idle state upon completion of the detection interval after the active transmissions are no longer detected on the one or more wireless communications channels.

Clause 8. The method of any of clauses 6 to 7, wherein: the detection interval occurs on a periodic basis; and the RIS controller transitions from an idle state to an active state at a start of each periodic detection interval.

Clause 9. The method of any of clauses 6 to 8, further comprising: receiving parameters for the detection interval from a user equipment (UE) over a sidelink channel, wherein the parameters are received via sidelink control information (SCI) signaling, medium access control-control element (MAC-CE) signaling, or a combination thereof.

Clause 10. The method of any of clauses 6 to 9, further comprising: transmitting preferred parameters for the detection interval to a base station or user equipment (UE).

Clause 11. The method of any of clauses 6 to 8, further comprising: receiving parameters for the detection interval from a base station, wherein the parameters are received via radio resource control (RRC) signaling, downlink control information (DCI) signaling, medium access control (MAC) signaling, or any combination thereof.

Clause 12. The method of any of clauses 1 to 11, further comprising: deactivating the RIS surface based on the active transmissions no longer being detected; deactivating the RIS surface upon expiration of a first time interval after the active transmissions are no longer detected; or any combination thereof.

Clause 13. The method of any of clauses 1 to 12, further comprising: transitioning the RIS controller between an idle state and an active state, and between the active state and the idle state; transmitting a first announcement based on transitioning from the idle state to the active state; and transmitting a second announcement based on transitioning from the active state to the idle state.

Clause 14. The method of any of clauses 1 to 13, further comprising: transmitting a third announcement message based on activating the RIS surface; and transmitting a fourth announcement message based on deactivating the RIS surface.

Clause 15. A method of wireless communication performed by a reconfigurable intelligent surface (RIS) controller, comprising: transmitting, to a network node, a first transition time capability of the RIS controller, wherein the first transition time capability corresponds to a time needed for the RIS controller to transition from an idle state to an active state; and transmitting, to the network node, a second transition time capability of the RIS controller, wherein the second transition time capability corresponds to a time needed for a RIS surface controlled by the RIS controller to transition from a deactivated state to an activated state.

Clause 16. The method of clause 15, wherein the first transition time capability is indicated based on: a frequency band served by the RIS controller; a frequency band combination served by the RIS controller; a carrier served by the RIS controller; a carrier combination served by the RIS controller; or any combination thereof.

Clause 17. The method of any of clauses 15 to 16, wherein the second transition time capability is indicated based on: a frequency band reflected by the RIS surface; a frequency band combination reflected by the RIS surface; a carrier reflected by the RIS surface; a carrier combination reflected by the RIS surface; or any combination thereof.

Clause 18. The method of any of clauses 15 to 17, wherein: the first transition time capability corresponds to a first number of symbols, a first number of slots, a first number of frames, a first number of subframes, or any combination thereof, for the RIS controller to transition from the idle state to the active state; and the second transition time capability corresponds to a second number of symbols, a second number of slots, a second number of frames, a second number of subframes, or any combination thereof, for the RIS surface controlled by the RIS controller to transition from the deactivated state to the activated state.

Clause 19. The method of any of clauses 15 to 18, further comprising: transmitting, to the network node, a third transition time capability of the RIS controller, wherein the third transition time capability corresponds to a time needed for the RIS controller to transition from the active state to the idle state; and transmitting, to the network node, a fourth transition time capability of the RIS controller, wherein the fourth transition time capability corresponds to a time needed for a RIS surface controlled by the RIS controller to transition from the activated state to the deactivated state.

Clause 20. The method of clause 19, wherein: the third transition time capability corresponds to a third number of symbols, a third number of slots, a third number of frames, a third number of subframes, or any combination thereof, for the RIS controller to transition from the active state to the idle state; and the fourth transition time capability corresponds to a fourth number of symbols, a fourth number of slots, a fourth number of frames, a fourth number of subframes, or any combination thereof, for the RIS surface controlled by the RIS controller to transition from the activated state to the deactivated state.

Clause 21. The method of any of clauses 19 to 20, wherein: the third transition time capability is indicated based on a frequency band served by the RIS controller, a frequency band combination served by the RIS controller, a carrier served by the RIS controller, a carrier combination served by the RIS controller, or any combination thereof; and the fourth transition time capability is indicated based on a frequency band reflected by the RIS surface, a frequency band combination reflected by the RIS surface, a carrier reflected by the RIS surface, a carrier combination reflected by the RIS surface, or any combination thereof.

Clause 22. A method of wireless communication performed by a reconfigurable intelligent surface (RIS) controller, comprising: transitioning to or remaining in an active state based on a first outcome of a first probability function; and transitioning to or remaining in an idle state based on a second outcome of the first probability function.

Clause 23. The method of clause 22, further comprising: receiving a first set of one or more configuration messages, wherein the first set of one or more configuration messages indicate: a first time duration for remaining in the active state in response to the first outcome; and a second time duration for remaining in the idle state in response to the second outcome of the first probability function.

Clause 24. The method of clause 23, further comprising: receiving the first set of one or more configuration messages from a base station, wherein the first set of one or more configuration messages are received via radio resource control (RRC) signaling, downlink control information (DCI) signaling, medium access control (MAC) signaling, or any combination thereof.

Clause 25. The method of any of clauses 23 to 24, wherein: the first time duration is indicated as a first number of symbols, a first number of sub-slots, a first number of slots, a first number of subframes, a first number of frames, a number of milliseconds, a sensing window, or any combination thereof; and the second time duration is indicated as a second number of symbols, a second number of sub-slots, a second number of slots, a second number of subframes, a second number of frames, a number of milliseconds, a sensing window, or any combination thereof.

Clause 26. The method of clause 23, further comprising: receiving the first set of one or more configuration messages from a user equipment (UE) over a sidelink channel, wherein the first set of one or more configuration messages are received via sidelink control information (SCI) signaling, medium access control-control element (MAC-CE) signaling, or a combination thereof.

Clause 27. The method of any of clauses 22 to 26, further comprising: transitioning the RIS surface from a deactivated state to an activated state based on a first outcome of a second probability function.

Clause 28. The method of clause 27, further comprising: maintaining the RIS surface in the deactivated state based on a second outcome of the second probability function.

Clause 29. The method of any of clauses 27 to 28, further comprising: receiving a second set of one or more configuration messages, wherein the second set of one or more configuration messages indicate a third time duration for maintaining the RIS surface in the activated state after the RIS surface is transitioned from the deactivated state to the activated state in response to the first outcome of the second probability function; a fourth time duration for maintaining the RIS surface in the deactivated state in response to the second outcome of the second probability function; or any combination thereof.

Clause 30. A reconfigurable intelligent surface (RIS) controller, comprising: a memory; at least one transceiver; and at least one processor communicatively coupled to the memory and the at least one transceiver, the at least one processor configured to: perform one or more channel sensing operations to detect whether there are active transmissions on one or more wireless communications channels from one or more network entities that the RIS controller is configured to assist; and transition a RIS surface coupled to the RIS controller from a deactivated state to an activated state based on detection of active transmissions on the one or more wireless communications channels from the one or more network entities that the RIS controller is configured to assist.

Clause 31. The RIS controller of clause 30, wherein the at least one processor is further configured to: determine whether the active transmissions are from the one or more network entities that the RIS controller is configured to assist by decoding physical downlink control channels (PDCCH) received from the one or more network entities.

Clause 32. The RIS controller of any of clauses 30 to 31, wherein: the RIS surface is transitioned to the activated state based on the active transmissions detected on the one or more wireless communications channels meeting a specified criterion.

Clause 33. The RIS controller of clause 32, wherein the specified criterion comprises: an explicit indication to transition the RIS surface to the activated state, wherein the explicit indication is indicated in a received control signal or received data signal from or associated with the one or more network entities that the RIS controller is configured to assist; the active transmissions received from the one or more network entities having a measured received signal strength indicator (RSSI) meeting an RSSI threshold; the active transmissions received from the one or more network entities having a measured reference signal received power (RSRP) meeting an RSRP threshold; the active transmissions received from the one or more network entities having a measured reference signal received quality (RSRQ) meeting an RSRQ threshold; the active transmissions received from the one or more network entities having a measured angle of arrival (AoA) meeting an AoA threshold; or any combination thereof.

Clause 34. The RIS controller of clause 33, wherein: the RSSI threshold, the RSRP threshold, the RSRQ threshold, the AoA threshold, or any combination thereof is compared to one or more measurements of the active transmissions, and the active transmissions comprise: demodulation reference signals (DMRS), downlink control information (DCI), sidelink control information (SCI), a physical downlink shared channel (PDSCH) signal, a physical sidelink shared channel (PSSCH) signal, or any combination thereof.

Clause 35. The RIS controller of any of clauses 30 to 34, wherein: the one or more channel sensing operations are performed during a detection interval, and the detection interval corresponds to a number of symbols, a number of sub-slots, a number of slots, a number of frames, a number of subframes, a number of milliseconds, a sensing window, or any combination thereof.

Clause 36. The RIS controller of clause 35, wherein the at least one processor is further configured to: transition to an idle state upon completion of the detection interval after the active transmissions are no longer detected on the one or more wireless communications channels.

Clause 37. The RIS controller of any of clauses 35 to 36, wherein: the detection interval occurs on a periodic basis; and the RIS controller transitions from an idle state to an active state at a start of each periodic detection interval.

Clause 38. The RIS controller of any of clauses 35 to 37, wherein the at least one processor is further configured to: receive, via the at least one transceiver, parameters for the detection interval from a user equipment (UE) over a sidelink channel, wherein the parameters are received via sidelink control information (SCI) signaling, medium access control-control element (MAC-CE) signaling, or a combination thereof.

Clause 39. The RIS controller of any of clauses 35 to 38, wherein the at least one processor is further configured to: transmit, via the at least one transceiver, preferred parameters for the detection interval to a base station or user equipment (UE).

Clause 40. The RIS controller of any of clauses 35 to 37, wherein the at least one processor is further configured to: receive, via the at least one transceiver, parameters for the detection interval from a base station, wherein the parameters are received via radio resource control (RRC) signaling, downlink control information (DCI) signaling, medium access control (MAC) signaling, or any combination thereof.

Clause 41. The RIS controller of any of clauses 30 to 40, wherein the at least one processor is further configured to: deactivate the RIS surface based on the active transmissions no longer being detected; deactivate the RIS surface upon expiration of a first time interval after the active transmissions are no longer detected; or any combination thereof.

Clause 42. The RIS controller of any of clauses 30 to 41, wherein the at least one processor is further configured to: transition the RIS controller between an idle state and an active state, and between the active state and the idle state; transmit, via the at least one transceiver, a first announcement based on transitioning from the idle state to the active state; and transmit, via the at least one transceiver, a second announcement based on transitioning from the active state to the idle state.

Clause 43. The RIS controller of any of clauses 30 to 42, wherein the at least one processor is further configured to: transmit, via the at least one transceiver, a third announcement message based on activating the RIS surface; and transmit, via the at least one transceiver, a fourth announcement message based on deactivating the RIS surface.

Clause 44. A reconfigurable intelligent surface (RIS) controller, comprising: a memory, at least one transceiver; and at least one processor communicatively coupled to the memory and the at least one transceiver, the at least one processor configured to: transmit, via the at least one transceiver, to a network node, a first transition time capability of the RIS controller, wherein the first transition time capability corresponds to a time needed for the RIS controller to transition from an idle state to an active state; and transmit, via the at least one transceiver, to the network node, a second transition time capability of the RIS controller, wherein the second transition time capability corresponds to a time needed for a RIS surface controlled by the RIS controller to transition from a deactivated state to an activated state.

Clause 45. The RIS controller of clause 44, wherein the first transition time capability is indicated based on: a frequency band served by the RIS controller; a frequency band combination served by the RIS controller; a carrier served by the RIS controller; a carrier combination served by the RIS controller; or any combination thereof.

Clause 46. The RIS controller of any of clauses 44 to 45, wherein the second transition time capability is indicated based on: a frequency band reflected by the RIS surface; a frequency band combination reflected by the RIS surface; a carrier reflected by the RIS surface; a carrier combination reflected by the RIS surface; or any combination thereof.

Clause 47. The RIS controller of any of clauses 44 to 46, wherein: the first transition time capability corresponds to a first number of symbols, a first number of slots, a first number of frames, a first number of subframes, or any combination thereof, for the RIS controller to transition from the idle state to the active state; and the second transition time capability corresponds to a second number of symbols, a second number of slots, a second number of frames, a second number of subframes, or any combination thereof, for the RIS surface controlled by the RIS controller to transition from the deactivated state to the activated state.

Clause 48. The RIS controller of any of clauses 44 to 47, wherein the at least one processor is further configured to: transmit, via the at least one transceiver, to the network node, a third transition time capability of the RIS controller, wherein the third transition time capability corresponds to a time needed for the RIS controller to transition from the active state to the idle state; and transmit, via the at least one transceiver, to the network node, a fourth transition time capability of the RIS controller, wherein the fourth transition time capability corresponds to a time needed for a RIS surface controlled by the RIS controller to transition from the activated state to the deactivated state.

Clause 49. The RIS controller of clause 48, wherein: the third transition time capability corresponds to a third number of symbols, a third number of slots, a third number of frames, a third number of subframes, or any combination thereof, for the RIS controller to transition from the active state to the idle state; and the fourth transition time capability corresponds to a fourth number of symbols, a fourth number of slots, a fourth number of frames, a fourth number of subframes, or any combination thereof, for the RIS surface controlled by the RIS controller to transition from the activated state to the deactivated state.

Clause 50. The RIS controller of any of clauses 48 to 49, wherein: the third transition time capability is indicated based on a frequency band served by the RIS controller, a frequency band combination served by the RIS controller, a carrier served by the RIS controller, a carrier combination served by the RIS controller, or any combination thereof; and the fourth transition time capability is indicated based on a frequency band reflected by the RIS surface, a frequency band combination reflected by the RIS surface, a carrier reflected by the RIS surface, a carrier combination reflected by the RIS surface, or any combination thereof.

Clause 51. A reconfigurable intelligent surface (RIS) controller, comprising: a memory; at least one transceiver; and at least one processor communicatively coupled to the memory and the at least one transceiver, the at least one processor configured to: transition to or remain in an active state based on a first outcome of a first probability function; and transition to or remain in an idle state based on a second outcome of the first probability function.

Clause 52. The RIS controller of clause 51, wherein the at least one processor is further configured to: receive, via the at least one transceiver, a first set of one or more configuration messages, wherein the first set of one or more configuration messages indicate: a first time duration for remaining in the active state in response to the first outcome; and a second time duration for remaining in the idle state in response to the second outcome of the first probability function.

Clause 53. The RIS controller of clause 52, wherein the at least one processor is further configured to: receive, via the at least one transceiver, the first set of one or more configuration messages from a base station, wherein the first set of one or more configuration messages are received via radio resource control (RRC) signaling, downlink control information (DCI) signaling, medium access control (MAC) signaling, or any combination thereof.

Clause 54. The RIS controller of any of clauses 52 to 53, wherein: the first time duration is indicated as a first number of symbols, a first number of sub-slots, a first number of slots, a first number of subframes, a first number of frames, a number of milliseconds, a sensing window, or any combination thereof; and the second time duration is indicated as a second number of symbols, a second number of sub-slots, a second number of slots, a second number of subframes, a second number of frames, a number of milliseconds, a sensing window, or any combination thereof.

Clause 55. The RIS controller of clause 52, wherein the at least one processor is further configured to: receive, via the at least one transceiver, the first set of one or more configuration messages from a user equipment (UE) over a sidelink channel, wherein the first set of one or more configuration messages are received via sidelink control information (SCI) signaling, medium access control-control element (MAC-CE) signaling, or a combination thereof.

Clause 56. The RIS controller of any of clauses 51 to 55, wherein the at least one processor is further configured to: transition the RIS surface from a deactivated state to an activated state based on a first outcome of a second probability function.

Clause 57. The RIS controller of clause 56, wherein the at least one processor is further configured to: maintain the RIS surface in the deactivated state based on a second outcome of the second probability function.

Clause 58. The RIS controller of any of clauses 56 to 57, wherein the at least one processor is further configured to: receive, via the at least one transceiver, a second set of one or more configuration messages, wherein the second set of one or more configuration messages indicate a third time duration for maintaining the RIS surface in the activated state after the RIS surface is transitioned from the deactivated state to the activated state in response to the first outcome of the second probability function; a fourth time duration for maintaining the RIS surface in the deactivated state in response to the second outcome of the second probability function; or any combination thereof.

Clause 59. A reconfigurable intelligent surface (RIS) controller, comprising: means for performing one or more channel sensing operations to detect whether there are active transmissions on one or more wireless communications channels from one or more network entities that the RIS controller is configured to assist; and means for transitioning a RIS surface coupled to the RIS controller from a deactivated state to an activated state based on detection of active transmissions on the one or more wireless communications channels from the one or more network entities that the RIS controller is configured to assist.

Clause 60. The RIS controller of clause 59, further comprising: means for determining whether the active transmissions are from the one or more network entities that the RIS controller is configured to assist by decoding physical downlink control channels (PDCCH) received from the one or more network entities.

Clause 61. The RIS controller of any of clauses 59 to 60, wherein: the RIS surface is transitioned to the activated state based on the active transmissions detected on the one or more wireless communications channels meeting a specified criterion.

Clause 62. The RIS controller of clause 61, wherein the specified criterion comprises: an explicit indication to transition the RIS surface to the activated state, wherein the explicit indication is indicated in a received control signal or received data signal from or associated with the one or more network entities that the RIS controller is configured to assist; the active transmissions received from the one or more network entities having a measured received signal strength indicator (RSSI) meeting an RSSI threshold; the active transmissions received from the one or more network entities having a measured reference signal received power (RSRP) meeting an RSRP threshold; the active transmissions received from the one or more network entities having a measured reference signal received quality (RSRQ) meeting an RSRQ threshold; the active transmissions received from the one or more network entities having a measured angle of arrival (AoA) meeting an AoA threshold; or any combination thereof.

Clause 63. The RIS controller of clause 62, wherein: the RSSI threshold, the RSRP threshold, the RSRQ threshold, the AoA threshold, or any combination thereof is compared to one or more measurements of the active transmissions, and the active transmissions comprise: demodulation reference signals (DMRS), downlink control information (DCI), sidelink control information (SCI), a physical downlink shared channel (PDSCH) signal, a physical sidelink shared channel (PSSCH) signal, or any combination thereof.

Clause 64. The RIS controller of any of clauses 59 to 63, wherein: the one or more channel sensing operations are performed during a detection interval, and the detection interval corresponds to a number of symbols, a number of sub-slots, a number of slots, a number of frames, a number of subframes, a number of milliseconds, a sensing window, or any combination thereof.

Clause 65. The RIS controller of clause 64, further comprising: means for transitioning to an idle state upon completion of the detection interval after the active transmissions are no longer detected on the one or more wireless communications channels.

Clause 66. The RIS controller of any of clauses 64 to 65, wherein: the detection interval occurs on a periodic basis; and the RIS controller transitions from an idle state to an active state at a start of each periodic detection interval.

Clause 67. The RIS controller of any of clauses 64 to 66, further comprising: means for receiving parameters for the detection interval from a user equipment (UE) over a sidelink channel, wherein the parameters are received via sidelink control information (SCI) signaling, medium access control-control element (MAC-CE) signaling, or a combination thereof.

Clause 68. The RIS controller of any of clauses 64 to 67, further comprising: means for transmitting preferred parameters for the detection interval to a base station or user equipment (UE).

Clause 69. The RIS controller of any of clauses 64 to 66, further comprising: means for receiving parameters for the detection interval from a base station, wherein the parameters are received via radio resource control (RRC) signaling, downlink control information (DCI) signaling, medium access control (MAC) signaling, or any combination thereof.

Clause 70. The RIS controller of any of clauses 59 to 69, further comprising: means for deactivating the RIS surface based on the active transmissions no longer being detected; means for deactivating the RIS surface upon expiration of a first time interval after the active transmissions are no longer detected; or any combination thereof.

Clause 71. The RIS controller of any of clauses 59 to 70, further comprising: means for transitioning the RIS controller between an idle state and an active state, and between the active state and the idle state; means for transmitting a first announcement based on transitioning from the idle state to the active state; and means for transmitting a second announcement based on transitioning from the active state to the idle state.

Clause 72. The RIS controller of any of clauses 59 to 71, further comprising: means for transmitting a third announcement message based on activating the RIS surface; and means for transmitting a fourth announcement message based on deactivating the RIS surface.

Clause 73. A reconfigurable intelligent surface (RIS) controller, comprising: means for transmitting, to a network node, a first transition time capability of the RIS controller, wherein the first transition time capability corresponds to a time needed for the RIS controller to transition from an idle state to an active state; and means for transmitting, to the network node, a second transition time capability of the RIS controller, wherein the second transition time capability corresponds to a time needed for a RIS surface controlled by the RIS controller to transition from a deactivated state to an activated state.

Clause 74. The RIS controller of clause 73, wherein the first transition time capability is indicated based on: a frequency band served by the RIS controller; a frequency band combination served by the RIS controller; a carrier served by the RIS controller; a carrier combination served by the RIS controller; or any combination thereof.

Clause 75. The RIS controller of any of clauses 73 to 74, wherein the second transition time capability is indicated based on: a frequency band reflected by the RIS surface; a frequency band combination reflected by the RIS surface; a carrier reflected by the RIS surface; a carrier combination reflected by the RIS surface; or any combination thereof.

Clause 76. The RIS controller of any of clauses 73 to 75, wherein: the first transition time capability corresponds to a first number of symbols, a first number of slots, a first number of frames, a first number of subframes, or any combination thereof, for the RIS controller to transition from the idle state to the active state; and the second transition time capability corresponds to a second number of symbols, a second number of slots, a second number of frames, a second number of subframes, or any combination thereof, for the RIS surface controlled by the RIS controller to transition from the deactivated state to the activated state.

Clause 77. The RIS controller of any of clauses 73 to 76, further comprising: means for transmitting, to the network node, a third transition time capability of the RIS controller, wherein the third transition time capability corresponds to a time needed for the RIS controller to transition from the active state to the idle state; and means for transmitting, to the network node, a fourth transition time capability of the RIS controller, wherein the fourth transition time capability corresponds to a time needed for a RIS surface controlled by the RIS controller to transition from the activated state to the deactivated state.

Clause 78. The RIS controller of clause 77, wherein: the third transition time capability corresponds to a third number of symbols, a third number of slots, a third number of frames, a third number of subframes, or any combination thereof, for the RIS controller to transition from the active state to the idle state; and the fourth transition time capability corresponds to a fourth number of symbols, a fourth number of slots, a fourth number of frames, a fourth number of subframes, or any combination thereof, for the RIS surface controlled by the RIS controller to transition from the activated state to the deactivated state.

Clause 79. The RIS controller of any of clauses 77 to 78, wherein: the third transition time capability is indicated based on a frequency band served by the RIS controller, a frequency band combination served by the RIS controller, a carrier served by the RIS controller, a carrier combination served by the RIS controller, or any combination thereof; and the fourth transition time capability is indicated based on a frequency band reflected by the RIS surface, a frequency band combination reflected by the RIS surface, a carrier reflected by the RIS surface, a carrier combination reflected by the RIS surface, or any combination thereof.

Clause 80. A reconfigurable intelligent surface (RIS) controller, comprising: means for transitioning to or remaining in an active state based on a first outcome of a first probability function; and means for transitioning to or remaining in an idle state based on a second outcome of the first probability function.

Clause 81. The RIS controller of clause 80, further comprising: means for receiving a first set of one or more configuration messages, wherein the first set of one or more configuration messages indicate: a first time duration for remaining in the active state in response to the first outcome; and a second time duration for remaining in the idle state in response to the second outcome of the first probability function.

Clause 82. The RIS controller of clause 81, further comprising: means for receiving the first set of one or more configuration messages from a base station, wherein the first set of one or more configuration messages are received via radio resource control (RRC) signaling, downlink control information (DCI) signaling, medium access control (MAC) signaling, or any combination thereof.

Clause 83. The RIS controller of any of clauses 81 to 82, wherein: the first time duration is indicated as a first number of symbols, a first number of sub-slots, a first number of slots, a first number of subframes, a first number of frames, a number of milliseconds, a sensing window, or any combination thereof; and the second time duration is indicated as a second number of symbols, a second number of sub-slots, a second number of slots, a second number of subframes, a second number of frames, a number of milliseconds, a sensing window, or any combination thereof.

Clause 84. The RIS controller of clause 81, further comprising: means for receiving the first set of one or more configuration messages from a user equipment (UE) over a sidelink channel, wherein the first set of one or more configuration messages are received via sidelink control information (SCI) signaling, medium access control-control element (MAC-CE) signaling, or a combination thereof.

Clause 85. The RIS controller of any of clauses 80 to 84, further comprising: means for transitioning the RIS surface from a deactivated state to an activated state based on a first outcome of a second probability function.

Clause 86. The RIS controller of clause 85, further comprising: means for maintaining the RIS surface in the deactivated state based on a second outcome of the second probability function.

Clause 87. The RIS controller of any of clauses 85 to 86, further comprising: means for receiving a second set of one or more configuration messages, wherein the second set of one or more configuration messages indicate a third time duration for maintaining the RIS surface in the activated state after the RIS surface is transitioned from the deactivated state to the activated state in response to the first outcome of the second probability function; a fourth time duration for maintaining the RIS surface in the deactivated state in response to the second outcome of the second probability function; or any combination thereof.

Clause 88. A non-transitory computer-readable medium storing computer-executable instructions that, when executed by a reconfigurable intelligent surface (RIS) controller, cause the RIS controller to: perform one or more channel sensing operations to detect whether there are active transmissions on one or more wireless communications channels from one or more network entities that the RIS controller is configured to assist, and transition a RIS surface coupled to the RIS controller from a deactivated state to an activated state based on detection of active transmissions on the one or more wireless communications channels from the one or more network entities that the RIS controller is configured to assist.

Clause 89. The non-transitory computer-readable medium of clause 88, further comprising computer-executable instructions that, when executed by the RIS controller, cause the RIS controller to: determine whether the active transmissions are from the one or more network entities that the RIS controller is configured to assist by decoding physical downlink control channels (PDCCH) received from the one or more network entities.

Clause 90. The non-transitory computer-readable medium of any of clauses 88 to 89, wherein: the RIS surface is transitioned to the activated state based on the active transmissions detected on the one or more wireless communications channels meeting a specified criterion.

Clause 91. The non-transitory computer-readable medium of clause 90, wherein the specified criterion comprises: an explicit indication to transition the RIS surface to the activated state, wherein the explicit indication is indicated in a received control signal or received data signal from or associated with the one or more network entities that the RIS controller is configured to assist; the active transmissions received from the one or more network entities having a measured received signal strength indicator (RSSI) meeting an RSSI threshold; the active transmissions received from the one or more network entities having a measured reference signal received power (RSRP) meeting an RSRP threshold; the active transmissions received from the one or more network entities having a measured reference signal received quality (RSRQ) meeting an RSRQ threshold; the active transmissions received from the one or more network entities having a measured angle of arrival (AoA) meeting an AoA threshold; or any combination thereof.

Clause 92. The non-transitory computer-readable medium of clause 91, wherein: the RSSI threshold, the RSRP threshold, the RSRQ threshold, the AoA threshold, or any combination thereof is compared to one or more measurements of the active transmissions, and the active transmissions comprise: demodulation reference signals (DMRS), downlink control information (DCI), sidelink control information (SCI), a physical downlink shared channel (PDSCH) signal, a physical sidelink shared channel (PSSCH) signal, or any combination thereof.

Clause 93. The non-transitory computer-readable medium of any of clauses 88 to 92, wherein: the one or more channel sensing operations are performed during a detection interval, and the detection interval corresponds to a number of symbols, a number of sub-slots, a number of slots, a number of frames, a number of subframes, a number of milliseconds, a sensing window, or any combination thereof.

Clause 94. The non-transitory computer-readable medium of clause 93, further comprising computer-executable instructions that, when executed by the RIS controller, cause the RIS controller to: transition to an idle state upon completion of the detection interval after the active transmissions are no longer detected on the one or more wireless communications channels.

Clause 95. The non-transitory computer-readable medium of any of clauses 93 to 94, wherein: the detection interval occurs on a periodic basis; and the RIS controller transitions from an idle state to an active state at a start of each periodic detection interval.

Clause 96. The non-transitory computer-readable medium of any of clauses 93 to 95, further comprising computer-executable instructions that, when executed by the RIS controller, cause the RIS controller to: receive parameters for the detection interval from a user equipment (UE) over a sidelink channel, wherein the parameters are received via sidelink control information (SCI) signaling, medium access control-control element (MAC-CE) signaling, or a combination thereof.

Clause 97. The non-transitory computer-readable medium of any of clauses 93 to 96, further comprising computer-executable instructions that, when executed by the RIS controller, cause the RIS controller to: transmit preferred parameters for the detection interval to a base station or user equipment (UE).

Clause 98. The non-transitory computer-readable medium of any of clauses 93 to 95, further comprising computer-executable instructions that, when executed by the RIS controller, cause the RIS controller to: receive parameters for the detection interval from a base station, wherein the parameters are received via radio resource control (RRC) signaling, downlink control information (DCI) signaling, medium access control (MAC) signaling, or any combination thereof.

Clause 99. The non-transitory computer-readable medium of any of clauses 88 to 98, further comprising computer-executable instructions that, when executed by the RIS controller, cause the RIS controller to: deactivate the RIS surface based on the active transmissions no longer being detected; deactivate the RIS surface upon expiration of a first time interval after the active transmissions are no longer detected; or any combination thereof.

Clause 100. The non-transitory computer-readable medium of any of clauses 88 to 99, further comprising computer-executable instructions that, when executed by the RIS controller, cause the RIS controller to: transition the RIS controller between an idle state and an active state, and between the active state and the idle state; transmit a first announcement based on transitioning from the idle state to the active state; and transmit a second announcement based on transitioning from the active state to the idle state.

Clause 101. The non-transitory computer-readable medium of any of clauses 88 to 100, further comprising computer-executable instructions that, when executed by the RIS controller, cause the RIS controller to: transmit a third announcement message based on activating the RIS surface; and transmit a fourth announcement message based on deactivating the RIS surface.

Clause 102. A non-transitory computer-readable medium storing computer-executable instructions that, when executed by a reconfigurable intelligent surface (RIS) controller, cause the RIS controller to: transmit, to a network node, a first transition time capability of the RIS controller, wherein the first transition time capability corresponds to a time needed for the RIS controller to transition from an idle state to an active state; and transmit, to the network node, a second transition time capability of the RIS controller, wherein the second transition time capability corresponds to a time needed for a RIS surface controlled by the RIS controller to transition from a deactivated state to an activated state.

Clause 103. The non-transitory computer-readable medium of clause 102, wherein the first transition time capability is indicated based on: a frequency band served by the RIS controller; a frequency band combination served by the RIS controller; a carrier served by the RIS controller; a carrier combination served by the RIS controller; or any combination thereof.

Clause 104. The non-transitory computer-readable medium of any of clauses 102 to 103, wherein the second transition time capability is indicated based on: a frequency band reflected by the RIS surface; a frequency band combination reflected by the RIS surface; a carrier reflected by the RIS surface; a carrier combination reflected by the RIS surface; or any combination thereof.

Clause 105. The non-transitory computer-readable medium of any of clauses 102 to 104, wherein: the first transition time capability corresponds to a first number of symbols, a first number of slots, a first number of frames, a first number of subframes, or any combination thereof, for the RIS controller to transition from the idle state to the active state; and the second transition time capability corresponds to a second number of symbols, a second number of slots, a second number of frames, a second number of subframes, or any combination thereof, for the RIS surface controlled by the RIS controller to transition from the deactivated state to the activated state.

Clause 106. The non-transitory computer-readable medium of any of clauses 102 to 105, further comprising computer-executable instructions that, when executed by the RIS controller, cause the RIS controller to: transmit, to the network node, a third transition time capability of the RIS controller, wherein the third transition time capability corresponds to a time needed for the RIS controller to transition from the active state to the idle state; and transmit, to the network node, a fourth transition time capability of the RIS controller, wherein the fourth transition time capability corresponds to a time needed for a RIS surface controlled by the RIS controller to transition from the activated state to the deactivated state.

Clause 107. The non-transitory computer-readable medium of clause 106, wherein: the third transition time capability corresponds to a third number of symbols, a third number of slots, a third number of frames, a third number of subframes, or any combination thereof, for the RIS controller to transition from the active state to the idle state; and the fourth transition time capability corresponds to a fourth number of symbols, a fourth number of slots, a fourth number of frames, a fourth number of subframes, or any combination thereof, for the RIS surface controlled by the RIS controller to transition from the activated state to the deactivated state.

Clause 108. The non-transitory computer-readable medium of any of clauses 106 to 107, wherein: the third transition time capability is indicated based on a frequency band served by the RIS controller, a frequency band combination served by the RIS controller, a carrier served by the RIS controller, a carrier combination served by the RIS controller, or any combination thereof; and the fourth transition time capability is indicated based on a frequency band reflected by the RIS surface, a frequency band combination reflected by the RIS surface, a carrier reflected by the RIS surface, a carrier combination reflected by the RIS surface, or any combination thereof.

Clause 109. A non-transitory computer-readable medium storing computer-executable instructions that, when executed by a reconfigurable intelligent surface (RIS) controller, cause the RIS controller to: transition to or remain in an active state based on a first outcome of a first probability function; and transition to or remain in an idle state based on a second outcome of the first probability function.

Clause 110. The non-transitory computer-readable medium of clause 109, further comprising computer-executable instructions that, when executed by the RIS controller, cause the RIS controller to: receive a first set of one or more configuration messages, wherein the first set of one or more configuration messages indicate a first time duration for remaining in the active state in response to the first outcome; and a second time duration for remaining in the idle state in response to the second outcome of the first probability function.

Clause 111. The non-transitory computer-readable medium of clause 110, further comprising computer-executable instructions that, when executed by the RIS controller, cause the RIS controller to: receive the first set of one or more configuration messages from a base station, wherein the first set of one or more configuration messages are received via radio resource control (RRC) signaling, downlink control information (DCI) signaling, medium access control (MAC) signaling, or any combination thereof.

Clause 112. The non-transitory computer-readable medium of any of clauses 110 to 111, wherein: the first time duration is indicated as a first number of symbols, a first number of sub-slots, a first number of slots, a first number of subframes, a first number of frames, a number of milliseconds, a sensing window, or any combination thereof; and the second time duration is indicated as a second number of symbols, a second number of sub-slots, a second number of slots, a second number of subframes, a second number of frames, a number of milliseconds, a sensing window, or any combination thereof.

Clause 113. The non-transitory computer-readable medium of clause 110, further comprising computer-executable instructions that, when executed by the RIS controller, cause the RIS controller to: receive the first set of one or more configuration messages from a user equipment (UE) over a sidelink channel, wherein the first set of one or more configuration messages are received via sidelink control information (SCI) signaling, medium access control-control element (MAC-CE) signaling, or a combination thereof.

Clause 114. The non-transitory computer-readable medium of any of clauses 109 to 113, further comprising computer-executable instructions that, when executed by the RIS controller, cause the RIS controller to: transition the RIS surface from a deactivated state to an activated state based on a first outcome of a second probability function.

Clause 115. The non-transitory computer-readable medium of clause 114, further comprising computer-executable instructions that, when executed by the RIS controller, cause the RIS controller to: maintain the RIS surface in the deactivated state based on a second outcome of the second probability function.

Clause 116. The non-transitory computer-readable medium of any of clauses 114 to 115, further comprising computer-executable instructions that, when executed by the RIS controller, cause the RIS controller to: receive a second set of one or more configuration messages, wherein the second set of one or more configuration messages indicate a third time duration for maintaining the RIS surface in the activated state after the RIS surface is transitioned from the deactivated state to the activated state in response to the first outcome of the second probability function; a fourth time duration for maintaining the RIS surface in the deactivated state in response to the second outcome of the second probability function; or any combination thereof.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless communication performed by a reconfigurable intelligent surface (RIS) controller, comprising:
performing one or more channel sensing operations to detect whether there are active transmissions on one or more wireless communications channels from one or more network entities that the RIS controller is configured to assist; and
transitioning a RIS surface coupled to the RIS controller from a deactivated state to an activated state based on detection of the active transmissions on the one or more wireless communications channels from the one or more network entities that the RIS controller is configured to assist.

2. The method of claim 1, further comprising:
determining whether the active transmissions are from the one or more network entities that the RIS controller is configured to assist by decoding physical downlink control channels (PDCCH) received from the one or more network entities.

3. The method of claim 1, wherein:
the RIS surface is transitioned to the activated state based on the active transmissions detected on the one or more wireless communications channels meeting a specified criterion.

4. The method of claim 3, wherein the specified criterion comprises:
an explicit indication to transition the RIS surface to the activated state, wherein the explicit indication is indicated in a received control signal or received data signal from or associated with the one or more network entities that the RIS controller is configured to assist;
the active transmissions received from the one or more network entities having a measured received signal strength indicator (RSSI) meeting an RSSI threshold;
the active transmissions received from the one or more network entities having a measured reference signal received power (RSRP) meeting an RSRP threshold;
the active transmissions received from the one or more network entities having a measured reference signal received quality (RSRQ) meeting an RSRQ threshold;
the active transmissions received from the one or more network entities having a measured angle of arrival (AoA) meeting an AoA threshold; or
any combination thereof.

5. The method of claim 4, wherein:
the RSSI threshold, the RSRP threshold, the RSRQ threshold, the AoA threshold, or any combination thereof is compared to one or more measurements of the active transmissions, and
the active transmissions comprise:
demodulation reference signals (DMRS),
downlink control information (DCI),
sidelink control information (SCI),
a physical downlink shared channel (PDSCH) signal,
a physical sidelink shared channel (PSSCH) signal, or
any combination thereof.

6. The method of claim 1, wherein:
the one or more channel sensing operations are performed during a detection interval, and the detection interval corresponds to a number of symbols, a number of sub-slots, a number of slots, a number of frames, a number of subframes, a number of milliseconds, a sensing window, or any combination thereof.

7. The method of claim 6, further comprising:
transitioning to an idle state upon completion of the detection interval after the active transmissions are no longer detected on the one or more wireless communications channels.

8. The method of claim 6, wherein:
the detection interval occurs on a periodic basis; and
the RIS controller transitions from an idle state to an active state at a start of each periodic detection interval.

9. The method of claim 6, further comprising:
receiving parameters for the detection interval from a user equipment (UE) over a sidelink channel, wherein the parameters are received via sidelink control information (SCI) signaling, medium access control-control element (MAC-CE) signaling, or a combination thereof.

10. The method of claim 6, further comprising:
transmitting preferred parameters for the detection interval to a base station or user equipment (UE).

11. The method of claim 6, further comprising:
receiving parameters for the detection interval from a base station, wherein the parameters are received via radio resource control (RRC) signaling, downlink control information (DCI) signaling, medium access control (MAC) signaling, or any combination thereof.

12. The method of claim 1, further comprising:
deactivating the RIS surface based on the active transmissions no longer being detected;
deactivating the RIS surface upon expiration of a first time interval after the active transmissions are no longer detected; or
any combination thereof.

13. The method of claim 1, further comprising:
transitioning the RIS controller between an idle state and an active state, and between the active state and the idle state;
transmitting a first announcement based on transitioning from the idle state to the active state; and
transmitting a second announcement based on transitioning from the active state to the idle state.

14. The method of claim 1, further comprising:
transmitting a third announcement message based on activating the RIS surface; and
transmitting a fourth announcement message based on deactivating the RIS surface.

15. A method of wireless communication performed by a reconfigurable intelligent surface (RIS) controller, comprising:
transmitting, to a network node, a first transition time capability of the RIS controller, wherein the first transition time capability corresponds to a time needed for the RIS controller to transition from an idle state to an active state; and
transmitting, to the network node, a second transition time capability of the RIS controller, wherein the second transition time capability corresponds to a time needed for a RIS surface controlled by the RIS controller to transition from a deactivated state to an activated state.

16. The method of claim 15, wherein the first transition time capability is indicated based on:
a frequency band served by the RIS controller;
a frequency band combination served by the RIS controller;
a carrier served by the RIS controller;
a carrier combination served by the RIS controller; or
any combination thereof.

17. The method of claim 15, wherein the second transition time capability is indicated based on:
a frequency band reflected by the RIS surface;
a frequency band combination reflected by the RIS surface;
a carrier reflected by the RIS surface;
a carrier combination reflected by the RIS surface; or any combination thereof.

18. The method of claim 15, wherein:
the first transition time capability corresponds to a first number of symbols, a first number of slots, a first number of frames, a first number of subframes, or any combination thereof, for the RIS controller to transition from the idle state to the active state; and
the second transition time capability corresponds to a second number of symbols, a second number of slots, a second number of frames, a second number of subframes, or any combination thereof, for the RIS surface controlled by the RIS controller to transition from the deactivated state to the activated state.

19. The method of claim 15, further comprising:
transmitting, to the network node, a third transition time capability of the RIS controller, wherein the third transition time capability corresponds to a time needed for the RIS controller to transition from the active state to the idle state; and
transmitting, to the network node, a fourth transition time capability of the RIS controller, wherein the fourth transition time capability corresponds to a time needed for a RIS surface controlled by the RIS controller to transition from the activated state to the deactivated state.

20. The method of claim 19, wherein:
the third transition time capability corresponds to a third number of symbols, a third number of slots, a third number of frames, a third number of subframes, or any combination thereof, for the RIS controller to transition from the active state to the idle state; and
the fourth transition time capability corresponds to a fourth number of symbols, a fourth number of slots, a fourth number of frames, a fourth number of subframes, or any combination thereof, for the RIS surface controlled by the RIS controller to transition from the activated state to the deactivated state.

21. The method of claim 19, wherein:
the third transition time capability is indicated based on
a frequency band served by the RIS controller,
a frequency band combination served by the RIS controller,
a carrier served by the RIS controller,
a carrier combination served by the RIS controller, or
any combination thereof; and
the fourth transition time capability is indicated based on
a frequency band reflected by the RIS surface,
a frequency band combination reflected by the RIS surface,
a carrier reflected by the RIS surface,
a carrier combination reflected by the RIS surface, or
any combination thereof.

22. A method of wireless communication performed by a reconfigurable intelligent surface (RIS) controller, comprising:
transitioning to or remaining in an active state based on a first outcome of a first probability function; and
transitioning to or remaining in an idle state based on a second outcome of the first probability function.

23. The method of claim 22, further comprising:
receiving a first set of one or more configuration messages, wherein the first set of one or more configuration messages indicate:
a first time duration for remaining in the active state in response to the first outcome; and
a second time duration for remaining in the idle state in response to the second outcome of the first probability function.

24. The method of claim 23, further comprising:
receiving the first set of one or more configuration messages from a base station, wherein the first set of one or more configuration messages are received via radio resource control (RRC) signaling, downlink control information (DCI) signaling, medium access control (MAC) signaling, or any combination thereof.

25. The method of claim 23, wherein:
the first time duration is indicated as a first number of symbols, a first number of sub-slots, a first number of slots, a first number of subframes, a first number of frames, a number of milliseconds, a sensing window, or any combination thereof; and
the second time duration is indicated as a second number of symbols, a second number of sub-slots, a second number of slots, a second number of subframes, a second number of frames, a number of milliseconds, a sensing window, or any combination thereof.

26. The method of claim 23, further comprising:
receiving the first set of one or more configuration messages from a user equipment (UE) over a sidelink channel, wherein the first set of one or more configuration messages are received via sidelink control information (SCI) signaling, medium access control-control element (MAC-CE) signaling, or a combination thereof.

27. The method of claim 22, further comprising:
transitioning the RIS surface from a deactivated state to an activated state based on a first outcome of a second probability function.

28. The method of claim 27, further comprising:
maintaining the RIS surface in the deactivated state based on a second outcome of the second probability function.

29. The method of claim 27, further comprising:
receiving a second set of one or more configuration messages, wherein the second set of one or more configuration messages indicate
a third time duration for maintaining the RIS surface in the activated state after the RIS surface is transitioned from the deactivated state to the activated state in response to the first outcome of the second probability function;
a fourth time duration for maintaining the RIS surface in the deactivated state in response to the second outcome of the second probability function; or
any combination thereof.

30. A reconfigurable intelligent surface (RIS) controller, comprising:
a memory;
at least one transceiver; and
at least one processor communicatively coupled to the memory and the at least one transceiver, the at least one processor configured to:
perform one or more channel sensing operations to detect whether there are active transmissions on one or more wireless communications channels from one or more network entities that the RIS controller is configured to assist; and
transition a RIS surface coupled to the RIS controller from a deactivated state to an activated state based on detection of active transmissions on the one or more wireless communications channels from the one or more network entities that the RIS controller is configured to assist.
